(19) United States
(12) Patent Application Publication
(10) Pub. No.: US 2026/0280672 A1
(43) Pub. Date: Sep. 17, 2026

(54) BEAM REPORTING FOR AI-ENABLED TIME DOMAIN PREDICTION

(71) Applicant: APPLE INC., Cupertino, CA (US)

(72) Inventors: Weidong Yang, San Diego, CA (US); Haitong Sun, Cupertino, CA (US); Dawei Zhang, Saratoga, CA (US); Wei Zeng, San Diego, CA (US); Huaning Niu, San Jose, CA (US); Oghenekome Oteri, San Diego, CA (US); Hong He, San Jose, CA (US)

(21) Appl. No.: 19/168,557

(22) PCT Filed: May 10, 2024
(86) PCT No.: PCT/US2024/028736

§ 371 Date: Sep. 24, 2025

Related U.S. Application Data
(60) Provisional application No. 63/501,875, filed on May 12, 2023.

(51) Int. Cl. H04B 7/06; H04L 5/00; H04W 72/044; H04W 72/23

(52) U.S. Cl. CPC H04B 7/06958; H04L 5/0094; H04W 72/046; H04W 72/23

(57) ABSTRACT

Systems and methods are provided for beam reporting using artificial intelligence (AI) or machine learning (ML) time domain prediction. A user equipment (UE) receives, from a base station, a first configuration for a first set of downlink (DL) reference signals (RSs); The UE measures the first set of DL RSs at a plurality of measurement occasions and, based on the measuring, determines one or more selected beams corresponding to the first set of DL RSs for reporting to the base station. The UE then transmits, to the base station, an indication of the one or more selected beams and feedback data corresponding to at least one of the one or more selected beams.

### TECHNICAL FIELD

This application relates generally to wireless communication systems, including beam management using artificial intelligence (AI) and/or machine learning (ML).

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates AI-based beam selection with partial measurements that may be used according to certain embodiments.

FIG. 2 illustrates an example of using an AI model or ML model to predict the information of downlink (DL) beam(s) for future time(s) based on historic measurement results according to certain embodiments.

FIG. 3 illustrates using an AI model or ML model for time domain prediction when the measured beams are the same as the predicted beams according to certain embodiments.

FIG. 4 illustrates using an AI model or ML model for time domain prediction when measured beams are not the same as predicted beams according to certain embodiments.

FIG. 5 illustrates different aspects that may be combined according to certain embodiments.

FIG. 6 illustrates a bitmap to indicate strong beams measured at a first occasion A1 according to one embodiment.

FIG. 7 illustrates a common bitmap used to indicate the strong beams for multiple occasions according to certain embodiments.

FIG. 8 is a flowchart illustrating a method for a UE to perform beam management with time domain prediction according to certain embodiments.

FIG. 9 is a flowchart illustrating a method for a base station to perform a time domain prediction for beam management according to certain embodiments.

FIG. 10 illustrates test data provisioning and performance monitoring for AI beam management according to certain embodiments.

FIG. 11 illustrates test data provisioning and performance monitoring for AI beam management according to certain embodiments.

FIG. 12 is a flowchart illustrating a method for a base station to provide test data to a UE for performance monitoring of a model for beam management according to certain embodiments.

FIG. 13 is a flowchart illustrating a method for performance monitoring by a UE of AI enabled beam management according to certain embodiments.

FIG. 14 illustrates an example architecture of a wireless communication system, according to embodiments disclosed herein.

FIG. 15 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

A beam management procedure may include the base station performing beam sweeping over multiple transmit beams. The base station may transmit, for example, a channel state information reference signal (CSI-RS) using each transmit beam for beam management. To enable the UE to perform receive beam sweeping, the base station may use a transmit beam to transmit (e.g., with repetitions) each CSI-RS at multiple times within the same reference signal (RS) resource set so that the UE can sweep through receive beams in multiple transmission instances. For example, if the base station has a set of N_1 transmit beams and the UE has a set of M_1 receive beams, the CSI-RS may be transmitted on each of the N_1 transmit beams M times so that the UE may receive M_1 instances of the CSI-RS per transmit beam. In other words, for each transmit beam of the base station, the UE may perform beam sweeping through the receive beams of the UE. As a result, the beam management procedure may enable the UE to measure a CSI-RS on different transmit beams using different receive beams to support selection of base station transmit beams/UE receive beam(s) beam pair(s). The UE may report the measurements to the base station to enable the base station to select one or more beam pair(s) for communication between the base station and the UE. While this example has been described in connection with CSI-RSs, the beam management process may also use synchronization signal blocks (SSBs) for beam management in a similar manner as described above.

Beamforming uses phased arrays to generate a highly directional transmission link to overcome pathloss attenuation for millimeter wave links. Directional links use fine alignment of transmit and receive beams that are achieved through a set of operations known as beam management, which includes beam selection, beam reporting, beam switching, beam tracking, etc. However, using a large number of antennas creates high overhead in beam management in terms of power and time consumption, reference signal overhead, and computational complexity. AI technology may be used to improve performance and reduce overhead by predicting the quality of beam pairs and selecting an optimal beam by using only a limited number of beam measurements.

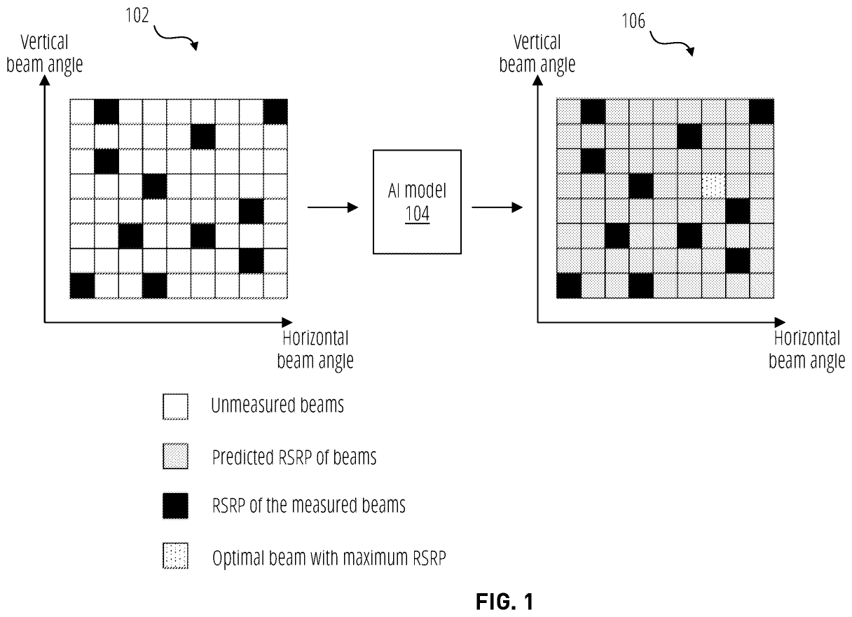

For example, FIG. 1 illustrates AI-based beam selection with partial measurements that may be used according to certain embodiments. In the illustrated example, a UE may measure and report the reference signal received power (RSRP) for only some of the beams at a first time 102. The base station may use an AI model 104 to predict the RSRP of other beams at a second time 106 in the future. The base station may also use the AI model 104 to predict an optimal or strongest beam with a maximum RSRP. The base station may then notify the UE of optimal or strongest beam. Thus, rather than reporting the RSRP of all beam pairs by an exhaustive beam searching, The AI model 104 (or ML model) allows the UE to reduce overhead by measuring and reporting the RSRP for only some of the beams.

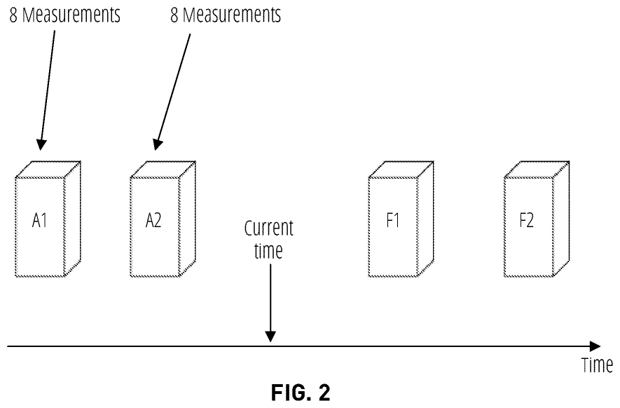

FIG. 2 illustrates an example of using an AI model or ML model to predict the information of downlink (DL) beam(s) for future time(s) based on historic measurement results according to certain embodiments. In the illustrated example, the UE measures multiple beams (e.g., performs RSRP measurements on eight RS beams) at a first measurement occasion A1 and again at a second measurement occasion A2. At a given time (e.g., a current time), the base station or the UE uses the AI/ML model to determine the best beams or beam pairs to use at a first future time F1 and a second future time F2.

In certain embodiments of the example shown in FIG. 2, beams in multiple instances or measurement occasions of a set B are used to predict beams in a set A for one or more time instances. Based on measurements at the measurement occasion A1 and the second measurement occasion A2 (each block for set B beams), the beam prediction for set A beams is generated at two time instances (first future time F1 and second future time F2).

There may be various options for the set A beams and the set B beams. In a first alternative (Alt.1), set A beams and set B beams are different from one another (i.e., set B is not a subset of set A). In a second alternative (Alt.2), set B beams are a subset of set A beams (but, set A and set B are not the same). In a third alternative (Alt.3), set A beams and set B beams are the same. It may be noted that the beam patterns of set A and set B may be selected based on a particular implementation. It may be noted that set B may be defined as a set of beams the UE performs measurements for, or a subset of beams the UE performs measurements for, and the RSRPs from beams in that set are used as inputs for an AI/ML model.

### Examples for Set A and Set B

The network can configure measurement resources such as SSBs, CSI-RS resources, channel state information (CSI) resource sets, CSI resource configuration, etc. for a UE to conduct beam measurement.

When using beams in multiple instances of set B to predict beams in set A for one or more time instances, the UE may perform beam measurement at a number of occasions M. The occasions may be indexed by their starting time. For example, the slot and/or orthogonal frequency division multiplexing (OFDM) symbol at least one measurement resource is present. To simplify the discussion below, it may be assumed that the measurement occasions are indexed by 1, . . . , M corresponding to starting time t₁, t₂, . . . , t_{M}. For each occasion, the UE may perform beam measurements over a number of measurement resources Pₘ, for 1≤m≤M. In some cases, P₁=P_{M}, i.e., the number of measurements is taken for each occasion.

In certain embodiments, set A, which is for the set of beams for which the AI model generates prediction, include CSI-RS resources, e.g., {NZP-CSI-RS-ResourceId-1, NZP-CSI-RS-ResourceId-2, . . . , NZP-CSI-RS-ResourceId-32} for non-zero power (NZP) CSI-RS resources.

In certain embodiments, set A, which is for the set of beams for which the AI model generates prediction, includes SSBs, e.g., {ssb-Index SSB-Index-1, ssb-Index SSB-Index-1, . . . , ssb-Index SSB-Index-8}.

In certain embodiments, set A, which is for the set of beams for which the AI model generates prediction, may include SSB(s) and CSI-RS resources, e.g., {ssb-Index SSB-Index-1, ssb-Index SSB-Index-1, . . . , ssb-Index SSB-Index-8} and {NZP-CSI-RS-ResourceId-1, NZP-CSI-RS-ResourceId-2, . . . , NZP-CSI-RS-ResourceId-32}, which can be provided by two sets of resources, one for SSBs another for CSI-RS resources.

In certain embodiments (e.g., for Alt.3 discussed above), set A, which is for the set of beams for which the AI model generates prediction, may include CSI-RS resources, e.g., {NZP-CSI-RS-ResourceId-1, NZP-CSI-RS-ResourceId-2, . . . , NZP-CSI-RS-ResourceId-32}.

In certain embodiments, the measurement set (set B) may include CSI-RS resources. When each CSI-RS resource is associated with a NZP-CSI-RS-ResourceId (as in 3GPP Technical Specification (TS) 38.331), then the set B includes CSI-resources from {NZP-CSI-RS-ResourceId-1, NZP-CSI-RS-ResourceId-2, . . . , NZP-CSI-RS-ResourceId-32}.

In certain embodiments (e.g., for Alt.2 discussed above), set A, which is for the set of beams for which the AI model generates prediction, may include CSI-RS resources, e.g., {NZP-CSI-RS-ResourceId-1, NZP-CSI-RS-ResourceId-2, . . . , NZP-CSI-RS-ResourceId-32}.

The measurement set (set B) may include CSI-RS resources. When each CSI-RS resource is associated with a NZP-CSI-RS-ResourceId (as in 3GPP TS 38.331), then the set B includes CSI-resources from {NZP-CSI-RS-ResourceId-2, NZP-CSI-RS-ResourceId-4, . . . , NZP-CSI-RS-ResourceId-27}.

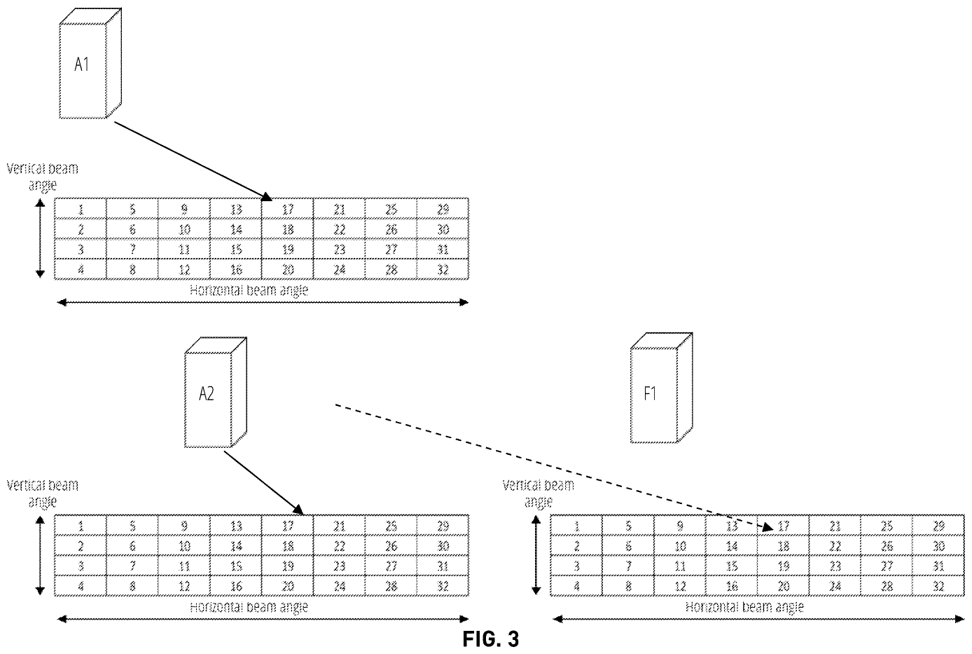

When set B equals set A (e.g., Alt.3 above where both set A and set B are {1, 2, . . . 32}), time domain beam prediction may not depend on the correlation among spatial beams. For example, FIG. 3 illustrates using an AI model or ML model for time domain prediction when the measured beams are the same as the predicted beams according to certain embodiments. Even though the UE does not know how two different beams are correlated, by the two measurements of beam 17 at the first measurement occasion A1 and the second measurement occasion A2, by using a Long Short Term Memory (LSTM) model, the RSRP of the beam 17 at the first future time F1 may be predicted. In this case, the time domain prediction at the UE is feasible and does not require analog beam information from the base station (e.g., gNB).

When set B does not equal set A (e.g., Alt.1 or Alt.2 above where set B={2, 4, 9, 11, 18, 20, 25, 27} and set A={1, 2, . . . , 32}), then the transmit beams' analog beam information from the base station is useful for time domain prediction. However, acquiring the analog beam information at UE side may be difficult. For example, infrastructure vendors may be reluctant to disclose such information. In such cases, it may be more feasible for the base station to perform inference based on the measurements on set B by the UE.

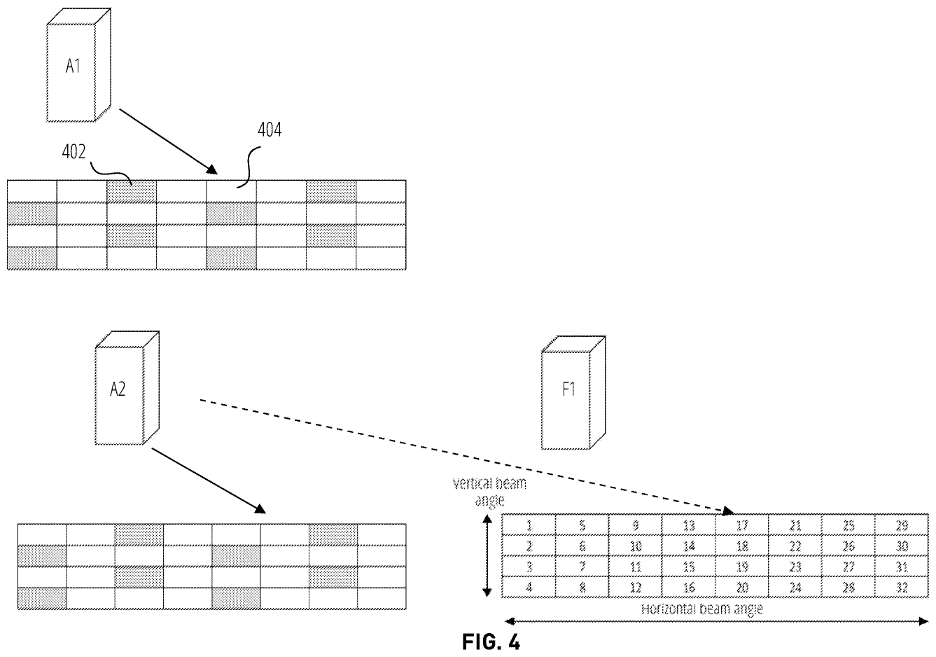

For example, FIG. 4 illustrates using an AI model or ML model for time domain prediction when measured beams are not the same as predicted beams according to certain embodiments. In this example, the UE measures the RSRP of some of the beams 402 (the illustrated shaded beams) at the first measurement occasion A1 and the second measurement occasion A2. The UE does not measure other beams 404 (the illustrated unshaded beams). Because the UE does not have the analog beam information indicating how the measured beams are correlated to the unmeasured beams, the UE may not be able to accurately predict the RSRP of the unmeasured beam 17 at the first future time F1.

Conventionally, the network may react to the beam measurement by the UE, and the number of reported beams in a beam report may be limited. As can be seen from the example FIG. 4, however, the number of reported beams may be large. For clarity in the illustration, only two instances of set B measurements are shown. In practice, more instances may be used. Following the conventional beam reporting, the feedback overhead can be too much, which may make AI-based beam management less useful.

Thus, certain embodiments herein reduce the feedback overhead when the measured beams (i.e., set B) are different than the predicted beams (set A) and AI-based beam management for time domain inference is performed at the network side (e.g., base station). Certain such embodiments reduce feedback overhead by indicating strong beams through one or more bitmaps or combinatorial indexes. In addition, or in other embodiments, quantization of the strongest beam may be per occasion or across occasions, and corresponding differential quantization is provided. Certain embodiments also use two part feedback for beam reporting to handle varying uplink control information (UCI) payload size.

Other embodiments use a similar reporting scheme for test data sent from the base station to a UE for performance monitoring of the AI model by the UE.

### Selection and Indication of Strong Beams.

In one aspect (Aspect A), when the UE indicates strong beams to the network, the RSRP reporting for weak beams may be omitted.

In one embodiment of Aspect A (Embodiment A-1), the selection and indication of strong beams may be per occasion. Thus, beam strength fluctuations may be accommodated among occasions. In one such embodiment, the number of selected strong beams may be fixed (e.g., by a standard specification) and/or set by a network configuration. For example, the network may configure a percentage of set B beams. In another such embodiment, the number of selected strong beams may vary within a certain range (e.g., constrained by the standard specification and/or network configuration) depending on the UE's decision. For example, the network may configure a percentage of set B beams (e.g., 25% or 50%) and the UE may select the number of set B beams within the range. The range can be prescribed by an upper limit, a lower limit, or both an upper limit and a lower limit on the number of reported beams.

In another embodiment of Aspect A (Embodiment A-2), the selection and indication of strong beams may be across a group of occasions. Thus, channel correlation may be exploited to save feedback overhead on the indication of strong beams. In one such embodiment, the number of selected strong beams may be fixed (e.g., by a standard specification) and/or set by a network configuration. In another such embodiment, the number of selected strong beams may vary within a certain range (e.g., constrained by specification and/or network configuration) depending on the UE's decision. The range can be prescribed by an upper limit, a lower limit, or both an upper limit and a lower limit on the number of reported beams.

### Quantization Scheme for RSRP(s)

In another aspect (Aspect B), different quantization schemes may be selected for reporting RSRP values.

In one embodiment of Aspect B (Embodiment B-1), one or more (N) reference beams may be selected as reference beam(s). The RSRP of each of the rest of the reported beams is quantized with respect to the RSRP of a reference beam, with differential quantization. Thus, the overhead is reduced.

In another embodiment of Aspect B (Embodiment B-2), RSRPs of beams are quantized separately (without differential quantization). Thus, the accuracy report beam strengths may be increased (e.g., at the cost of increased overhead).

### Quantizer Design

In another aspect (Aspect C), different quantizer designs may be selected to reduce overhead for beam reporting.

In one embodiment of Aspect C (Embodiment C-1), uniform quantization (in the logarithm domain) with ceiling and/or rounding and/or floor functions may be used. This design may provide simplicity and compatibility with the legacy designs.

In another embodiment of Aspect C (Embodiment C-2), non-uniform quantization (in the logarithm domain) with ceiling and/or rounding and/or floor functions may be used. Non-uniform quantization may provide an improved quantizer performance as compared to the performance provided by uniform quantization.

The inventors have observed, from simulation evaluation, that with a quantization step of 1 dB for the RSRP of the reference beam (i.e., the strongest beam), a quantization step of 2 dB for the differential RSRP, and 30 dB dynamic range, the inference accuracy is acceptable, as compared to the case without quantization on RSRP. It can be understood that for weak beams, the differential RSRP values can be set to a low value (e.g. to −30 dB) without substantially impacting the inference performance. Further, it may be possible to change the quantization steps. For example, in a goal to minimize quantization error, the quantization boundaries can be identified for example from the Lloyd's algorithm.

### Selection and Indication of Reference Beam(s).

In another aspect (Aspect D), the selection and indication of reference beams may be per measurement occasion or per group of measurement occasions.

In one embodiment of Aspect D (Embodiment D-1), for each occasion, a reference beam may be selected. In particular, a fixed number (N) of reference beams may be selected. For example, for N=2, one reference beam n is selected among a group n of measurement resources at a single occasion, 1≤n≤N. This may help bring awareness of channel dynamics to the network. Group 1 may correspond to analog beam(s) associated with one polarization at the base station antenna array. Group 2 may correspond to analog beam(s) associated with another polarization at the base station antenna array. For N=1, in certain embodiments, a single reference beam is selected for all the measurement resources at a single occasion. In another example, multiple set B patterns (e.g., set B pattern 1 and set B pattern 2 are interlaced and the number of beams in their union set is one half of the number of beams in set A) are utilized for beam measurements. Then occasions with the same set pattern can be grouped together, and N may correspond to the number of set B patterns or a multiple of a the number of set B patterns (e.g., there are 2 set B patterns yet N=4 so there can be two groups for each set B patterns).

In another embodiment of Aspect D (Embodiment D-2), for a group of occasions, a reference beam is selected. In particular, a fixed number (N) of reference beams may be selected. For example, for N=2, one reference beam n is selected among a group n of measurement resources across a group of occasions, 1≤n≤N. For N=1, in certain embodiments, a single reference beam is selected for all the measurement resources across a group of occasions or all occasions. This may reduce feedback overhead.

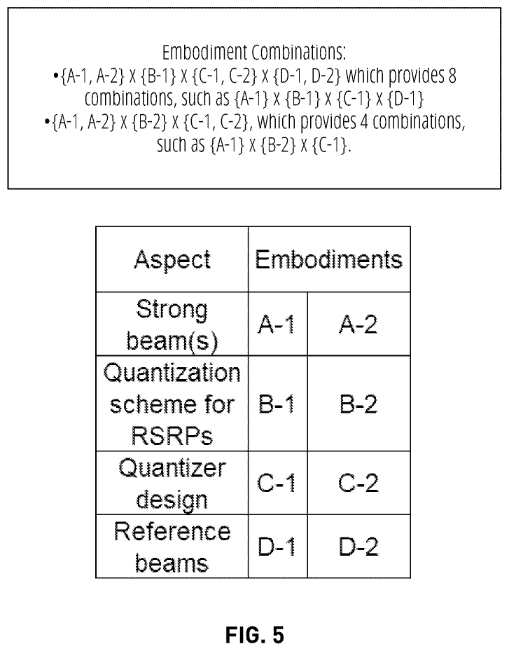

FIG. 5 illustrates different aspects that may be combined according to certain embodiments. As shown, when embodiment B-1 is selected to use N reference beams, the embodiment combinations include {A-1, A-2}×{B-1}×{C-1, C-2}×{D-1, D-2}, which provides eight combinations, such as {A-1}×{B-1}×{C-1}×{D-1}. Alternatively, selecting embodiment B-2 and reference beams are not used, the embodiment combinations include {A-1, A-2}×{B-2}×{C-1, C-2}, which provides four combinations, such as {A-1}×{B-2}×{C-1}.

### Example Embodiment—Bitmap with Strong Beams er Occasion

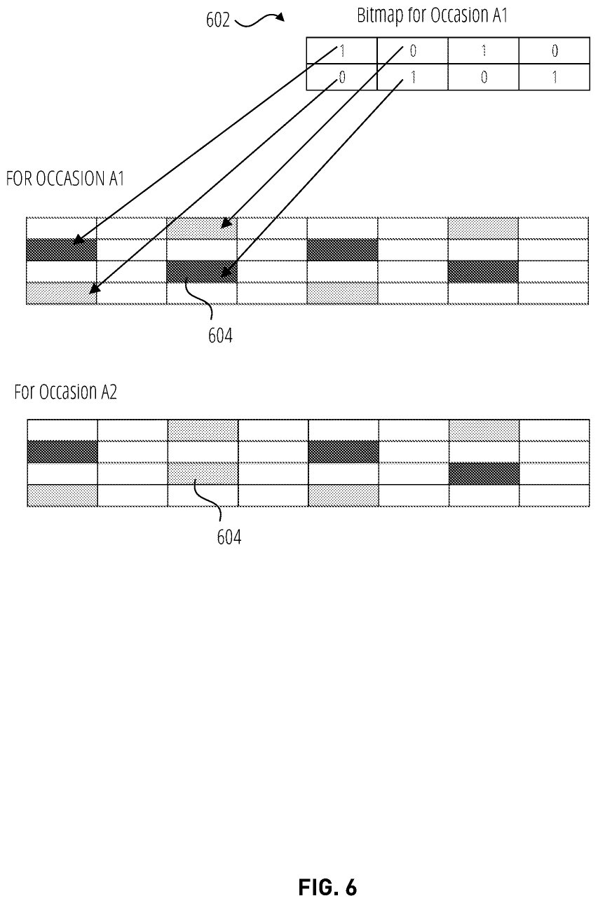

In one embodiment, a bitmap is used to indicate strong beams within the set of measured beams. For example, FIG. 6 illustrates a bitmap 602 to indicate strong beams measured at a first occasion A1 according to one embodiment. The dark shaded beams correspond to strong beams, which are each represented as a “1” in the bitmap 602. For beams represented as a “0” in the bitmap 602 (light shaded beams), the differential RSRP can be assumed to be of a small value (e.g., −30 dB), which may not need to be reported by the UE. Note for each occasion, the strong beams may be different. For example, a beam 604 may be measured with a strong RSRP value at occasion A1 and with a weak RSRP value at occasion A2. Thus, while the bitmap 602 for the occasion A1 has “1” for beam 604, a bitmap (not shown) for occasion A2 would have a “0” for beam 604. Thus, different bitmaps are useful for different measurement occasions. In certain embodiments, for each occasion, the strongest beam is identified and its RSRP is quantized with high resolution. When using a bitmap, it may be useful to order measurement resources. For example, measurement resources may be ordered according to the CSI-RS resource index or other schemes (e.g., in a row first fashion, or column first fashion, etc.) so as to achieve a common understanding between UE and gNB on the indication of strong beams.

### Example Embodiment—Combinatorial Index with Strong Beams er Occasion

In one embodiment, a combinatorial index may be used to indicate strong beams within the set of measured beams. The construction of a combinatorial index may be referred to, for example, in 3GPP TS 38.214. For each occasion, the strong beams may be different. Hence different combinatorial indexes are motivated. The combinatorial index can be designed to indicate a fixed number of selected beams or a number of selected beams within a range. For each occasion, the strongest beam may be identified and its RSRP is quantized with a high resolution.

With combinatorial indexing, it may be useful to selectively order measurement resources. For example, measurement resources may be ordered according to the CSI-RS resource index or other schemes (e.g., in a row first fashion, or column first fashion, etc.) so as to achieve a common understanding between UE and gNB on the indication of strong beams.

### Example Embodiment—Bitmap with Strongest Beams Across Occasions

In one embodiment, a bitmap may be used to indicate strong beams within the set of measured beams. As discussed above with reference to FIG. 6, for each occasion, the strong beams may be different. Thus, different bitmaps may be motivated. The strongest beam among all occasions or a group of occasions may be identified, and differentiation encoding for the rest of beams may be according to the identified strongest beam.

### Example Embodiment—Combinatorial Index with Strongest Beam Across Occasions

In one embodiment, a combinatorial index may be used to indicate strong beams within the set of measured beams. The construction of a combinatorial index may be referred to, for example, in 3GPP TS 38.214. For each occasion, the strong beams may be different. Thus, different combinatorial indexes may be motivated. The strongest beam among all occasions or a group of occasions may be identified, and differentiation encoding for the rest of beams may be according to the identified strongest beam.

### Common Bitmap or Combinatorial Index for Multiple Occasions.

Considering the time-domain correlation between beams, even though the strong beams' indices may vary with time (e.g., the occasion index, A1, A2, etc.), using a single bitmap or a single combinatorial index for a group of occasions or all occasions may be more efficient as the bitmap or combinatorial index does not directly contribute to the RSRP feedback. Thus, in certain embodiments, a single bitmap or combinatorial index used for multiple occasions.

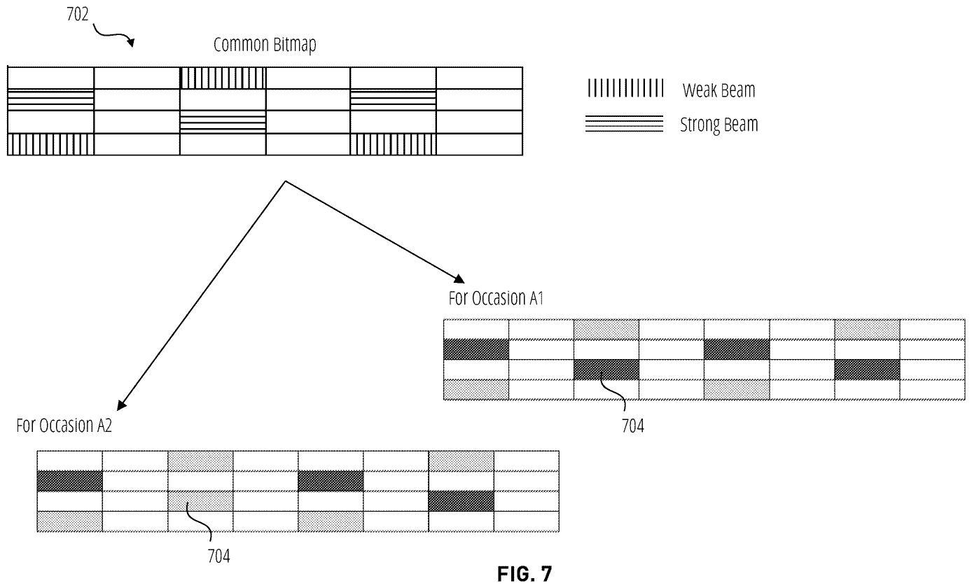

For example, FIG. 7 illustrates a common bitmap 702 used to indicate the strong beams for occasion A1 and for occasion A2 according to certain embodiments. For illustrative purposes, the weak beams and strong beams in the common bitmap 702 are shown using different patterns. However, skilled persons will recognize from the disclosure herein that a bitmap would use ones and zeros to distinguish between weak and strong beams. In the illustrated example, the common bitmap 702 indicates a beam 704 as a strong beam even though it is measured with a stronger RSRP at the first occasion A1 and a weaker RSRP at the second occasion. If multiple set B patterns (e.g., set B pattern 1 and set B pattern 2) are utilized, occasions can be associated with different set B patterns (e.g., Occasion 1 & 3 with Set B pattern 1, Occasion 2 & 4 with Set B pattern 2; or in another example Occasion 1 & 2 with Set B pattern 1, Occasion 3 & 4 with Set B pattern 2). Then there may a separate common bitmap/combinatorial index for each group of occasions, and there may be a separate strongest beam indication for each group of occasions.

### Two Part-Feedback for Beam Reporting.

It may be noted that if the differential RSRP is used, for all the schemes considered, then depending on channel condition, the number of beams not associated with the lowest RSRP values (e.g., −30 dB for differential beams) may vary. Consequently, the beam reporting size may vary, which may lead to many blind detections on the network side to decode the beam report. To avoid blind detection on the network side, according to certain embodiments, two part feedback is provided.

For example, in one embodiment a beam report that indicates one or more strong beams includes two parts. A first part of the beam report is of a fixed size and indicates the number of strong beams being reported. A second part of the beam report is of a variable size, based on the number of strong beams indicated in the first part, to report the RSRP values of the strong beams.

In certain embodiments, when multiple bitmaps are reported for different occasions, the first part of the beam report comprises a sum of the “1”s in the reported bitmaps. In other embodiments, when a common bitmap is reported for multiple occasions, the first part of the beam report comprises the total number of “1”s in the common bitmap. In addition, or in other embodiments, one code state may be assigned to represent the lowest RSRP or lowest differential RSRP (e.g., −30 dB).

### Example Beam Reporting Embodiments

Certain embodiments assume there are M occasions and P measurements per occasion (for example P=8). On the UE side, there are M. P measurements. At the baseband of the UE modem, the received signal can be represented by a linear scale or in dB scale (e.g., in dBm). In the following description, the signal representation with the dB scale is used. Similar embodiments can be derived for the case with signal representation with the linear scale.

Let the measured signals be S_{m,p} dBm, 1≤m≤M, 1≤p≤P.

The network can configure R the number of reported beams (“strong beams”) as fraction of the set B size, e.g., R=f(β·P) is the number of reported beams, f(x) is a round, ceiling or floor function, and β is a fraction, e.g., β=0.25 or β=0.5. The fraction can be provided by radio resource control (RRC) signaling or media access control (MAC) control element (CE), or a number of candidate values for β are configured by RRC signaling or MAC CE to the UE. Then, one is selected through dynamic signaling (code point in a DCI for example) for a beam report.

The network can configure R directly, without the use of β (e.g., for P=8, the network can configure R=5 for the UE). R can be provided by RRC signaling or MAC CE, or a number of candidate values for β are configured by RRC signaling or MAC CE to the UE. Then, one of them is selected through dynamic signaling (code point in a DCI for example) for a beam report.

The selection of R beams out of B beams can be conducted through a bitmap or combinatorial indexing. The selection can be for a single occasion, a group of occasions or all M occasions. When M is large, a common selection for all M occasions may not be suitable, and M occasions may be divided into groups of occasions through specification and/or network configuration.

In some embodiments, the UE chooses precisely R beams out of P beams. If a P-bit bitmap is used, “1”s are used for indicating selected beams, and the number of “1” in the bitmap is R. If a combinatorial indexing scheme is used, then the combinatorial index is given by

$$⌈ ( {log}_{2} ( {C}_{R}^{P} ) ) ⌉ ,$$

where

$$( {C}_{Rx}^{y} )$$

is the number of x-combinations from the set with y elements.

In some embodiments, the UE can choose fewer than R beams for reporting. If a P-bit bitmap is used, “1”s are used for indicating selected beams, and the number of “1”s in the bitmap can be fewer than R. If a combinatorial indexing scheme is used, then the combinatorial index is given by

$$⌈ ( {log}_{2} ( {\sum }_{r = {R}_{lowest}}^{R} {C}_{r}^{P} ) ) ,$$

where R_{lowest} is the lowest number of reported beams. For example, from a performance point of view, if there are at least two reported beams from a specification and/or a network configuration, then R_{lowest}=2. In some embodiments, R_{lowest}=1 can be used as well.
Quantization with a Reference Per Occasion.

Continuing with the above example, certain embodiments provide quantization with a reference beam per occasion. At a given m, the largest among S_{m,p}, 1≤p≤P is found, let it be S_{m,p}, and pᵣ is the beam index within the set B beams.

Regarding signaling for the reference beam, the strongest beam's location or indexing with the set B may be signaled to the network through a bitmap, e.g., a P-bitmap with “1” at location pᵣ, and “0”s elsewhere. Alternatively, the strongest beam's location or indexing with the set B can be signaled to the network through a combinatorial index

$$⌈ ( {log}_{2} ( {C}_{1}^{P} ) ) ⌉ .$$

The signaling for the reference beam can be also combined with the selection of R beams out of P beams. A two-step procedure may be used, where a first step includes a strongest beam (reference beam) indication that consumes

$${C}_{1}^{P}$$

code states, and where a second step is conditioned on the indication of the strongest beam. To signal the selection R-1 beams from the remaining P-1 beams, the number of code states for the second step is

$${C}_{R - 1}^{P - 1} .$$

Considering both steps, the total number of code states is

$${C}_{1}^{P} \cdot {C}_{R - 1}^{P - 1} ,$$

and the signaling overhead is given by

$$⌈ ( {log}_{2} ( ( {C}_{1}^{P} ) \cdot ( {C}_{R - 1}^{P - 1} ) ) ) ⌉ .$$

Under some conditions (e.g., P=16, R=1), four bits can be saved through joint-signaling of reference beam and beam selection. Alternately, the selection can be through a first step where R beams out of P beams are selected, and a second step where 1 out of R beams is selected (the strongest beam): signaling overhead is given by

$$⌈ ( {log}_{2} ( ( {C}_{R}^{P} ) \cdot ( {C}_{1}^{R} ) ) ) ⌉ .$$

Quantization with a Reference per a Group of Occasions

Continuing with the above example, certain embodiments provide quantization with a reference beam per a group of occasions. To simplify notations, it is assumed all the M occasions form a group. The largest among S_{m,p}, 1≤m≤M 1≤p≤P is found, let it be Smᵣ, pᵣ, and mᵣ is selected occasion index, pᵣ is the beam index within the set B beams.

For signaling the reference beam, the strongest beam's location or indexing with the set B can be signaled to the network through two parts. In one option, two parts are both with bitmaps. Bitmap-1 may be a P-bitmap with “1” at location pᵣ, and “0”s elsewhere. Bitmap-2 may be an M-bit map, with “1” at occasion mᵣ, and “0” elsewhere. In other cases, two parts can be with combinatorial indexing, or one part is by bitmap and another part is by combinatorial indexing.

The strongest beam's location or indexing with the set B over all occasions can be signaled to the network through a combinatorial index

$$⌈ ( {log}_{2} ( {C}_{1}^{( M \cdot P )} ) ) ⌉$$

or by indication of the selected occasion within the group and the indication of the selected beam at the selected occasion.

For joint encoding with common reported beam selection across occasions, the signaling for the reference beam can be also combined with the selection of R beams out of P beams, and a two-step procedure can be followed. Assuming a common selection of reported beams (“strong beams”) across occasions, a first step includes the strongest beam (reference beam) indication that consumes

$${C}_{1}^{( M \cdot P )}$$

code states, and the second step is conditioned on the indication of the strongest beam. Then, to signal the selection R-1 beams from the remaining P-1 beams, the number of code states for the second step is

$${C}_{R - 1}^{P - 1} .$$

Considering both steps, the total number of code states is

$${C}_{1}^{( M \cdot P )} \cdot {C}_{R - 1}^{P - 1} ,$$

and the signaling overhead is given by

$$⌈ ( {log}_{2} ( ( {C}_{1}^{( M \cdot P )} ) \cdot ( {C}_{R - 1}^{P - 1} ) ) ) ⌉ .$$

It can be verified under some conditions, e.g., P=16, R=1, 4 bits can be saved through joint-signaling of reference beam and beam selection. Alternately, the selection can be through a first step where R beams out of P beams are selected, and a second step where 1 out of R beams is selected (the strongest beam): signaling overhead is given by

$$⌈ ( {log}_{2} ( ( {C}_{R}^{P} ) \cdot ( {C}_{1}^{M R} ) ) ) ⌉ or ⌈ ( {log}_{2} ( ( {C}_{R}^{P} ) \cdot ( {C}_{1}^{R} ) ( {C}_{1}^{M} ) ) ) ⌉$$

(the latter is for separate signaling of the occasion with the strongest beam and the indication of the strongest beam among R selected beams at the occasion).

For joint encoding with separate reported beam selection at occasions, the signaling for the reference beam can also be combined with the selection of R beams out of P beams, and a two-step procedure can be followed. Assuming separate reported beam (“strong beams”) selection at occasions, a first step includes the strongest beam (reference beam) indication that consumes

$${C}_{1}^{( M \cdot P )}$$

code states, and the second step at occasion m is conditioned on the indication of the strongest beam. Then, to signal the selection R-1 beams from the remaining P-1 beams, the number of code states for the second step is

$${C}_{R - 1}^{P - 1}$$

for occasion m. Logically, it may be possible that the beam with beam index pᵣ is not selected for occasion m, but the chance is remote. If that is a valid consideration, then the selection per occasion can be changed to

$${C}_{R}^{P} .$$

Considering both steps, the total number of code states is

$${C}_{1}^{( M \cdot P )} \cdot {( {C}_{R - 1}^{P - 1} )}^{M} ,$$

and the signaling overhead is given by

$$⌈ ( {log}_{2} ( ( {C}_{1}^{( M \cdot P )} ) \cdot {( {C}_{R - 1}^{P - 1} )}^{M} ) ) ⌉ .$$

As the number of total code states can be very large number, for easier parsing on the network side, certain embodiments use separate signaling of reference beam and reported beam selections. Variations as shown above for switching selection steps can be constructed.

### Differential Quantization.

Continuing with the above example, certain embodiments provide differential quantization, wherein a quantizer Q(·) is applied to S_{m,p}−S_{m,p}_{ᵣ} or S_{m,p}−Sₘ_{ᵣ}_{,p}_{ᵣ} depending on design choice taken above. The quantizer can be uniform, which is characterized by the highest value (e.g., 0) the lowest value (e.g., −40), and a quantization step. In some embodiments, the quantizer can be non-uniform. The design of non-uniform quantizer can be through the application the Lloyd's algorithm, wherein optimal quantization boundaries are found and quantization error is minimized. The quantization error metric can be in the linear domain, in the dB domain, etc.

### Example Beam Reporting Processes

FIG. 8 is a flowchart illustrating a method 800 for a UE to perform beam management with time domain prediction according to certain embodiments. The method 800 includes receiving 802, at the UE from a base station, a first configuration for a first set of downlink (DL) reference signals (RSS). The method 800 further includes measuring 804, at the UE, the first set of DL RSs at a plurality of measurement occasions. In certain embodiments, the DL RSs in the first set may be periodic, semi-persistent, or aperiodic reference signals. In certain embodiments, all DL RSs in the first set are constrained to be either periodic or semi-persistent or aperiodic. For periodic reference signals, its period and an offset within a period are RRC configured; semi-persistent reference signals can also be associated with a period and an offset. Aperiodic reference signals can be triggered by dynamic signaling. In certain embodiments, measurement occasions include reference signals from different periods. In certain embodiments, a measurement occasion includes a cluster of reference signals within a period, the time gap between two adjacent reference signals within a cluster can be uniform or non-uniform. In certain embodiments, a measurement occasion includes reference signals from clusters from more than one period. Based on the measuring, the method 800 includes determining 806 one or more selected beams corresponding to the first set of DL RSs for reporting to the base station. The method 800 further includes transmitting 808, from the UE to the base station, an indication of the one or more selected beams and feedback data corresponding to at least one of the one or more selected beams.

In certain embodiments, the method 800 optionally includes receiving 810, at the UE from the base station, a second configuration for a second set of DL RSs based on the feedback data for the time domain prediction.

In certain embodiments of the method 800, determining the one or more selected beams comprises selecting the one or more selected beams per occasion of the plurality of measurement occasions. A fixed number of the one or more selected beams per occasion may be predetermined or configured by the base station.

Certain embodiments of the method 800 further include determining, by the UE, a number of the one or more selected beams per occasion is within a predetermined range or a range configured by the base station.

In certain embodiments of the method 800, the indication of the one or more selected beams comprises a first bitmap per occasion indicating the one or more selected beams.

In certain embodiments of the method 800, the indication of the one or more selected beams comprises a first combinatorial index per occasion indicating the one or more selected beams. The first combinatorial index may be given by

$$⌈ ( {log}_{2} ( {C}_{R}^{P} ) ) ⌉$$

for a combinatorial function

$${c}_{R}^{P} ,$$

R number of reported beams, and P number of measurements per occasion.

In certain embodiments of the method 800, the UE is configured to select up to R number of reported beams, and the first combinatorial index is given by

$$⌈ ( {log}_{2} ( {\sum }_{r = {R}_{lowest}}^{R} {C}_{r}^{P} ) )$$

for a combinatorial function

$${C}_{R}^{P}$$

and P number or measurements per occasion, where r is an index and R_{lowest} is a lowest number of reported beams selected by the UE. The feedback data may include reference signal received power (RSRP) data for the one or more selected beams per occasion. In certain such embodiments, the feedback data does not explicitly include the RSRP data for non-selected beams corresponding to the first set of DL RSs measured by the UE.

In certain embodiments, the method 800 further includes indicating, from the UE to the base station, a strongest beam per occasion of the plurality of measurement occasions; and quantizing an RSRP value of the strongest beam per occasion with a higher resolution as compared to a lower resolution used for quantizing the RSRP data of a remainder of the one or more selected beams per occasion. Certain such embodiments further include quantizing the RSRP data of the remainder of the one or more selected beams per occasion using differential quantization with respect to the RSRP value of the strongest beam per occasion. The differential quantization may include a uniform quantization function based on a high value, a low value, and a quantization step. Or, the differential quantization may include a non-uniform quantization function based on determining quantization boundaries and minimizing a quantization error. Indicating the strongest beam per occasion may include using a second bitmap or a second combinatorial index given by

$$⌈ ( {log}_{2} ( {C}_{1}^{P} ) ) ⌉ .$$

In certain embodiments of the method 800, determining the one or more selected beams comprises selecting the one or more selected beams across a group of occasions of the plurality of measurement occasions. A fixed number of the one or more selected beams across the group of occasions may be predetermined or configured by the base station. Certain embodiments further include determining, by the UE, a number of the one or more selected beams across the group of occasions is within a predetermined range or a range configured by the base station. The indication of the one or more selected beams may include one or more first bitmap indicating the one or more selected beams across the group of occasions. The indication of the one or more selected beams may include one or more first combinatorial index indicating the one or more selected beams across the group of occasions. The first combinatorial index may be given by

$$⌈ ( {log}_{2} ( {C}_{R}^{P} ) ) ⌉$$

for a combinatorial function

$${C}_{R}^{P}$$

R number of reported beams, and P number of measurements across the group of occasions. Alternatively, the UE is configured to select up to R number of reported beams, and the first combinatorial index is given

$$⌈ ( {log}_{2} ( {\sum }_{r = {R}_{lowest}}^{R} {C}_{r}^{P} ) )$$

for a combinatorial function

$${C}_{R}^{P}$$

and P number or measurements across the group of occasions, where r is an index and R_{lowest} is a lowest number of reported beams selected by the UE. The feedback data may include reference signal received power (RSRP) data for the one or more selected beams across the group of occasions. In other embodiments, the feedback data does not explicitly include the RSRP data for non-selected beams corresponding to the first set of DL RSs measured by the UE.

In certain embodiments, the method 800 further includes: indicating, from the UE to the base station, a strongest beam in the group of occasions of the plurality of measurement occasions; and quantizing an RSRP value of the strongest beam in the group of occasions with a higher resolution as compared to a lower resolution used for quantizing the RSRP data of a remainder of the one or more selected beams across the group of occasions. The method may further include quantizing the RSRP data of the remainder of the one or more selected beams across the group of occasions using differential quantization with respect to the RSRP value of the strongest beam in the group of occasions. The differential quantization may include a uniform quantization function based on a high value, a low value, and a quantization step. Or, the differential quantization may include a non-uniform quantization function based on determining quantization boundaries and minimizing a quantization error. Indicating the strongest beam in the group of occasions may include using a second bitmap or a second combinatorial index given by

$$⌈ ( {log}_{2} ( {C}_{1}^{( M \cdot P )} ) ) ⌉$$

for M occasions in the group of occasions.

In certain embodiments of the method 800, transmitting the indication of the one or more selected beams and the feedback data comprises generating a report including: a first part with a fixed size to indicate a number of the one or more selected beams; and a second part with a variable size based on the number of the one or more selected beams to report corresponding reference signal received power (RSRP) data.

Embodiments contemplated herein include an apparatus comprising means to perform one or more elements of the method 800. This apparatus may be, for example, an apparatus of a UE (such as a wireless device 1502 that is a UE, as described herein).

Embodiments contemplated herein include one or more non-transitory computer-readable media comprising instructions to cause an electronic device, upon execution of the instructions by one or more processors of the electronic device, to perform one or more elements of the method 800. This non-transitory computer-readable media may be, for example, a memory of a UE (such as a memory 1506 of a wireless device 1502 that is a UE, as described herein).

Embodiments contemplated herein include an apparatus comprising logic, modules, or circuitry to perform one or more elements of the method 800. This apparatus may be, for example, an apparatus of a UE (such as a wireless device 1502 that is a UE, as described herein).

Embodiments contemplated herein include an apparatus comprising: one or more processors and one or more computer-readable media comprising instructions that, when executed by the one or more processors, cause the one or more processors to perform one or more elements of the method 800. This apparatus may be, for example, an apparatus of a UE (such as a wireless device 1502 that is a UE, as described herein).

Embodiments contemplated herein include a signal as described in or related to one or more elements of the method 800.

Embodiments contemplated herein include a computer program or computer program product comprising instructions, wherein execution of the program by a processor is to cause the processor to carry out one or more elements of the method 800. The processor may be a processor of a UE (such as a processor(s) 1504 of a wireless device 1502 that is a UE, as described herein). These instructions may be, for example, located in the processor and/or on a memory of the UE (such as a memory 1506 of a wireless device 1502 that is a UE, as described herein).

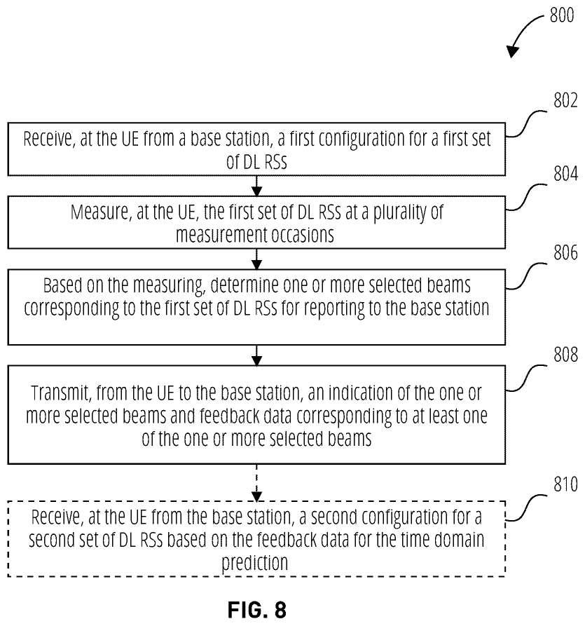

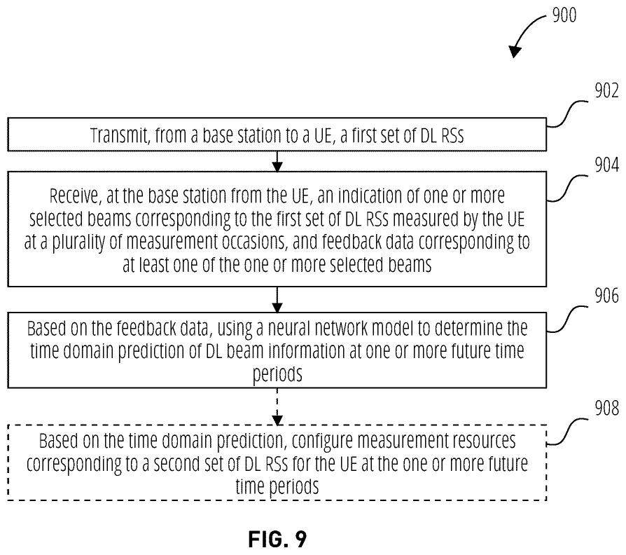

FIG. 9 is a flowchart illustrating a method 900 for a base station to perform a time domain prediction for beam management according to certain embodiments. The method 900 includes transmitting 902, from a base station to a user equipment (UE), a first set of downlink (DL) reference signals (RSS). The method 900 further includes receiving 904, at the base station from the UE, an indication of one or more selected beams corresponding to the first set of DL RSs measured by the UE at a plurality of measurement occasions, and feedback data corresponding to at least one of the one or more selected beams. The method 900 further includes, based on the feedback data, using 906 a neural network model to determine the time domain prediction of DL beam information at one or more future time periods.

In certain embodiments, the method 900 further includes, based on the time domain prediction, configuring 908 measurement resources corresponding to a second set of DL RSs for the UE at the one or more future time periods. In certain embodiments, the DL RSs in the first set may be periodic, semi-persistent, or aperiodic reference signals. In certain embodiments, all DL RSs in the first set are constrained to be either periodic or semi-persistent or aperiodic. For periodic reference signals, its period and an offset within a period are RRC configured; semi-persistent reference signals can also be associated with a period and an offset. Aperiodic reference signals can be triggered by dynamic signaling. In certain embodiments, measurement occasions include reference signals from different periods. In certain embodiments, a measurement occasion includes a cluster of reference signals within a period, the time gap between two adjacent reference signals within a cluster can be uniform or non-uniform. In certain embodiments, a measurement occasion includes reference signals from clusters from more than one period.

In certain embodiments of the method 900, the one or more selected beams are selected per occasion of the plurality of measurement occasions. A fixed number of the one or more selected beams per occasion is predetermined or configured by the base station. Or, a number of the one or more selected beams per occasion is within a predetermined range or a range configured by the base station.

In certain embodiments of the method 900, the indication of the one or more selected beams comprises a first bitmap per occasion indicating the one or more selected beams or a first combinatorial index per occasion indicating the one or more selected beams. The first combinatorial index may be given by

$$⌈ ( {log}_{2} ( {C}_{R}^{P} ) ) ⌉$$

for a combinatorial function

$${C}_{R}^{P} ,$$

R number of reported beams, P number of measurements per occasion.

In certain embodiments of the method 900, up to R number of reported beams may be selected, and the first combinatorial index is given

$$⌈ ( {log}_{2} ( {\sum }_{r = {R}_{lowest}}^{R} {C}_{r}^{P} ) )$$

for a combinatorial function

$${C}_{R}^{P}$$

and P number of measurements per occasion, where r is an index and R_{lowest} is a lowest number of reported beams selected by the UE. The feedback data may include reference signal received power (RSRP) data for the one or more selected beams per occasion. Or, the feedback data does not explicitly include the RSRP data for non-selected beams corresponding to the first set of DL RSs measured by the UE.

In certain embodiments, the method 900 further includes receiving, from the UE at the base station: another indication of a strongest beam per occasion of the plurality of measurement occasions; and a quantized RSRP value of the strongest beam per occasion with a higher resolution as compared to a lower resolution used for quantizing the RSRP data of a remainder of the one or more selected beams per occasion. The RSRP data of the remainder of the one or more selected beams per occasion may be quantized using differential quantization with respect to the RSRP value of the strongest beam per occasion, or the differential quantization comprises a uniform quantization function based on a high value, a low value, and a quantization step. The differential quantization may be a non-uniform quantization function based on quantization boundaries and a minimized quantization error. In certain embodiments, another indication of the strongest beam per occasion comprises a second bitmap or a second combinatorial index given by

$$⌈ ( {log}_{2} ( {C}_{1}^{P} ) ) ⌉ .$$

In certain embodiments of the method 900, the one or more selected beams are selected across a group of occasions of the plurality of measurement occasions. A fixed number of the one or more selected beams across the group of occasions may be predetermined or configured by the base station. Or, a number of the one or more selected beams across the group of occasions may be within a predetermined range or a range configured by the base station. The indication of the one or more selected beams may include one or more first bitmap indicating the one or more selected beams across the group of occasions or one or more first combinatorial index indicating the one or more selected beams across the group of occasions. The first combinatorial index may be given by

$$⌈ ( {log}_{2} ( {C}_{R}^{P} ) ) ⌉$$

for a combinatorial function

$${C}_{R}^{P} ,$$

R number of reported beams, P number of measurements across the group of occasions. In certain embodiments, up to R number of reported beams are selected, and the first combinatorial index is given

$$⌈ ( {log}_{2} ( {\sum }_{r = {R}_{lowest}}^{R} {C}_{r}^{P} ) )$$

for a combinatorial function

$${C}_{R}^{P}$$

and P number of measurements across the group of occasions, where r is an index and R_{lowest} is a lowest number of reported beams selected by the UE. The feedback data may include reference signal received power (RSRP) data for the one or more selected beams across the group of occasions. In certain embodiments, the feedback data does not explicitly include the RSRP data for non-selected beams corresponding to the first set of DL RSs measured by the UE.

In certain embodiments, the method 900 further includes receiving, from the UE at the base station: another indication of a strongest beam in the group of occasions of the plurality of measurement occasions; and a quantized RSRP value of the strongest beam in the group of occasions with a higher resolution as compared to a lower resolution used for quantizing the RSRP data of a remainder of the one or more selected beams across the group of occasions. The RSRP data of the remainder of the one or more selected beams across the group of occasions may be quantized using differential quantization with respect to the RSRP value of the strongest beam in the group of occasions. The differential quantization may include a uniform quantization function based on a high value, a low value, and a quantization step. In other embodiments, the differential quantization comprises a non-uniform quantization function based on quantization boundaries and a minimized quantization error. The another indication of the strongest beam in the group of occasions

$$⌈ ( {log}_{2} ( {C}_{1}^{( M \cdot P )} ) ) ⌉$$

may include a second bitmap or a second combinatorial index given by for M occasions in the group of occasions.

In certain embodiments of the method 900, the indication of the one or more selected beams and the feedback data comprises a report including: a first part with a fixed size to indicate a number of the one or more selected beams; and a second part with a variable size based on the number of the one or more selected beams to report corresponding reference signal received power (RSRP) data.

In certain embodiments, the AI/ML inference is performed on the UE side, and the feedback overhead of the one or more output of the AI/ML inference model for one or more time epochs can be reduced in a similar fashion as for measurements from measurement occasions including aspects of beam selection and indication, quantizer scheme, quantizer design and reference beam selection and indication.

Embodiments contemplated herein include an apparatus comprising means to perform one or more elements of the method 900. This apparatus may be, for example, an apparatus of a base station (such as a network device 1518 that is a base station, as described herein).

Embodiments contemplated herein include one or more non-transitory computer-readable media comprising instructions to cause an electronic device, upon execution of the instructions by one or more processors of the electronic device, to perform one or more elements of the method 900. This non-transitory computer-readable media may be, for example, a memory of a base station (such as a memory 1522 of a network device 1518 that is a base station, as described herein).

Embodiments contemplated herein include an apparatus comprising logic, modules, or circuitry to perform one or more elements of the method 900. This apparatus may be, for example, an apparatus of a base station (such as a network device 1518 that is a base station, as described herein).

Embodiments contemplated herein include an apparatus comprising: one or more processors and one or more computer-readable media comprising instructions that, when executed by the one or more processors, cause the one or more processors to perform one or more elements of the method 900. This apparatus may be, for example, an apparatus of a base station (such as a network device 1518 that is a base station, as described herein).

Embodiments contemplated herein include a signal as described in or related to one or more elements of the method 900.

Embodiments contemplated herein include a computer program or computer program product comprising instructions, wherein execution of the program by a processing element is to cause the processing element to carry out one or more elements of the method 900. The processor may be a processor of a base station (such as a processor(s) 1520 of a network device 1518 that is a base station, as described herein). These instructions may be, for example, located in the processor and/or on a memory of the base station (such as a memory 1522 of a network device 1518 that is a base station, as described herein).

### Performance Monitoring for AI-Beam Management.

Certain embodiments disclosed herein consider the use of a test data set to conduct performance monitoring of the AI model on UE side. Various alternative message flows are provided for provisioning the test data set to the UE. In addition, or in other embodiments, different schemes are provided to reduce the overhead in delivering the test data set from the base station to the UE. For example, as discussed above with respect to reducing feedback overhead for AI-based beam management for time domain inference, reducing overhead for the test data set may include indicating selected input and/or output beams through one or more bitmaps or combinatorial indexes, quantization of the selected beam per time instance or across time instances, using differential quantization, and/or using two part signaling for the test data set to handle varying test data set sizes.

Table 1 shows three alternatives for model training and model inference. In a first option (Opt.1), AI/ML model training and inference may be performed on the network (NW) side. In a second option (Opt.2), AI/ML model training and inference may be performed on the UE side. In a third option (Opt.3), AI/ML model training is performed on the NW side and AI/ML model inference is performed on the UE side. For beam management, as discussed herein, the third option (Opt.3) is supported when the AI/ML model is transferred from the NW side to the UE side.

TABLE 1

| | Location for | Location for |
|---|---|---|
| | model training | model inference |
| Opt. 1 | NW side | NW side |
| Opt. 2 | UE side | UE side |
| Opt. 3 | NW side | UE side |

For beam management, UE-side model monitoring may include the UE monitoring the performance metric(s) and making decision(s) of model selection, activation, deactivation, switching, and/or fallback operations. Alternatively, in network-side model monitoring, the network monitors the performance metric(s) and makes decision(s) of model selection, activation, deactivation, switching, and/or fallback operations. In hybrid model monitoring, the UE monitors the performance metric(s) and the network makes decision(s) of model selection, activation, deactivation, switching, and/or fallback operations.

As shown in Table 2, NW side model monitoring can be readily supported for the option (Opt.1) where both the AI/ML model training and inference are performed on the NW side. The network has the beam measurements reported by the UE, and the ground truth can be obtained by configuring the UE with beam measurement/reporting (e.g., on SSB and/or CSI-RS resources). In certain embodiments, the suitability of an AI model may be guaranteed by design, and the performance monitoring is just a safety measure, which can be considered of a secondary importance.

TABLE 2

| | Location | Location | Model |
|---|---|---|---|
| | for model | for model | performance |
| | training | inference | monitoring |
| Opt. 1 | NW side | NW side | NW side model monitoring |
| | | | can be readily supported |
| Opt. 2 | UE side | UE side | |
| Opt. 3 | NW side | UE side | |

For the third option (Opt.3) shown in Table 2, the situation is somewhat similar to Opt.1, as the network side provisioned AI model may have been thoroughly tested by the network. However, as the model designer (network side) and model inference entity (UE) are not the same, the model performance monitoring is of more use in Opt.3 than it is in Opt.1.

For the second option (Opt.2) shown in Table 2, as the AI model is designed by the UE side, which does not have complete information about the network deployment/configuration, the AI model may be based on an educated guess. Note that there are some schemes with that use zone identifiers (IDs) or dataset IDs, which identify the network deployment/network configuration at the data collection stage and the network deployment/network configuration at the inference stage. A matching ID may suggest matching network deployment/network configuration, hence suitability for the use of the AI model.

However, such a zone ID/dataset ID, especially as global ones, may be used to reverse-engineer the network deployment/configuration. For example, an infrastructure vendor's or network operator's deployment of antenna modules (macro, pico, etc.), adjustment with time of the day, etc. may be collected, analyzed, and identified using the provided zone ID/dataset ID by the network in various geographical area. Infrastructure vendors and/or network operators may prefer that this hard-earned know-how not be acquired by competitor in a legitimate and relatively straightforward way.

It may be noted that Opt.2 tends to give UE vendors more design freedom. For example, for product differentiation, a more capable UE vendor can design, deploy, and use a better AI model than its competitors. Thus, it may be beneficial to use Opt.2.

### Test Data Provisioning and Ground Truth Data Provisioning.

For AI training and/or inference, validation data and test data may be used at different stages of the use of an AI model. For AI-enabled beam management, as described herein, test data may be used in one or both of a first case (Case.1) and a second case (Case.2).

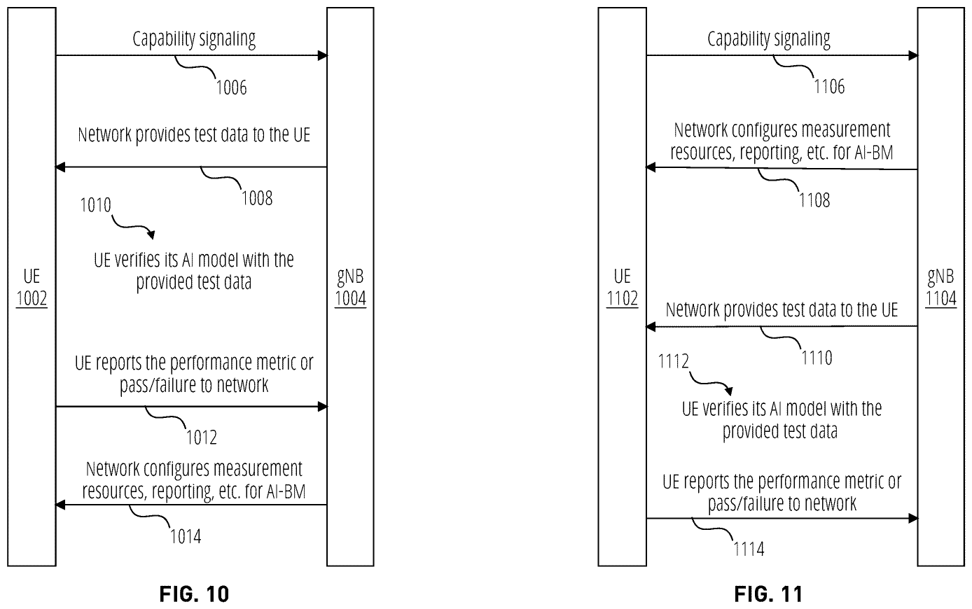

In the first case, test data may be provided even before AI-enabled beam management inference is activated. If the test result is not satisfactory, then the AI model is not activated and a conventional beam management approach is used. The first case uses a message exchange between the network and the UE. For example, FIG. 10 illustrates test data provisioning and performance monitoring for AI beam management for the first case according to certain embodiments. In the illustrated example, a UE 1002 sends capability signaling 1006 to a gNB 1004 to indicate the UE's ability for performance monitoring for AI beam management. In response, the gNB 1004 provides 1008 test data to the UE 1002, which the UE 1002 uses to verify 1010 it AI model. The model verification process may result in performance metric and/or a pass/fail indication for the model. The UE 1002 reports 1012 the performance metric and/or the pass/failure to the gNB 1004. The gNB 1004 then configures 1014 the UE 1002 with measurement resources, reporting, etc for AI-enabled beam management (AI-BM).

In the second case, test data may be provided after AI-enabled beam management inference is activated. The test data may be provided periodically, or semi-persistently, aperiodically (e.g., at the network's discretion). In certain embodiments, transmission of the test data may be event-triggered (e.g., a binding step of providing test data if some event is triggered).

For example, FIG. 11 illustrates test data provisioning and performance monitoring for AI beam management for the second case according to certain embodiments. In the illustrated example, a UE 1102 sends capability signaling 1106 to a gNB 1104 to indicate the UE's ability for performance monitoring for AI beam management. In response, the gNB 1104 configures 1108 the UE 1102 with measurement resources, reporting, etc for AI-BM. Then, the gNB 1104 provides 1110 test data to the UE 1102. The UE 1102 verifies 1112 its AI model with the provided test data and reports 1114 the performance metric and/or the pass/failure to the gNB 1104.

Selecting the first case (FIG. 10) may be based on a smoothness assumption for the beam management AI model. Typically, the AI model for AI beam management is much simpler than that for AI CSI, which may include several fully connected layers. By the universal approximation theorem, an arbitrary continuous function may be approximated by such an AI model, which may have abrupt changes within a small locale of the inputs. However, due to an AI beam management model being much simpler than an AI CSI model, the chance for abrupt changes in an AI beam management model may be much less than that for an AI CSI model. If the AI model trainer also ensures no abrupt changes in the output within small locale of the inputs (e.g., to ensure robust performance with quantization error or measurement error in the AI/ML inputs), then the AI beam management model is well-behaved and can be characterized by a number of samples (and interpolation with test samples can be assumed).

If RSRP measurement accuracy is not a critical issue, it may be enough to verify that the AI model (e.g., trained at the UE side) may approximate sufficiently close to the ground. Thus, the first case may be used for the verification of the mathematical model.

The justification for the second case (FIG. 11) goes one step further. The second case also verifies the UE measurement accuracy. For example, mathematically an AI model may generate close to enough output to the ground truth if the AI model is fed with inputs from highly accurate inputs. If, due to the UE's measurement error, the inference output may not aligned with the optimal choice for the UE for a large percentage of cases, then the AI model may still not be suitable for use.

### Test Data Signaling.

The test data signaling may include, for example, a control plane broadcast, a groupcast, or dedicated signaling.

Signaling the test data over the control plane with a broadcast (e.g., provided in a system information block (SIBx) message) allows the UEs in the cell to obtain the test data and the system overhead may be fixed. Alternately, a SIBx message provides broadcast schedule and transmission information of the test data, e.g., MCS level, number of PRBs, and number of OFDM symbols of PDSCH carrying the test data. Due to test data's size, multiple PDSCHs may be needed, and consequently the PDSCHs may be spread out in the time domain. A broadcast schedule allows a UE to acquire part of the test data from arbitrary position or more positions in the broadcast schedule compared to the case in which a UE is constrained to start test data acquisition from the very first segment of the test data.

For a groupcast, the test data may be carried over a physical downlink shared channel (PDSCH) scheduled by group-common downlink control information (DCI), or a physical downlink control channel (PDCCH) carrying the group-common DCI associated with a group-common radio network temporary identifier (RNTI). The signaling overhead may be amortized for multiple UEs and special needs may be tailored, e.g., for UEs concentrated in certain areas in a cell. A UE may be configured to such a group-common RNTI, and another UE may be configured with the same group-common RNTI.

For dedicated signaling, the test data may be included in a MAC CE or in the payload part of a PDSCH through the user plane. This may offer the highest flexibility, but may also be associated with the highest overhead.

### Test Data Composition.

For beam management using spatial domain prediction, a test data set may include multiple samples. Each sample includes an input part and an output part. For example, the input part comprises eight RSRP measurements from SSBs or eight CSI resources, and the output part comprises four beam IDs that are each associated with a CSI-RS resource/TCI state. In another example, the input part comprises eight RSRP measurements from SSBs or eight CSI resources, and the output part comprises four predicted RSRPs that are each associated with a CSI-RS resource. The predicted values may be formulated as relative values (e.g., the strongest RSRP is at 0 dB, the weakest RSRP is −40 dB, etc.).

For beam management using time domain prediction, a test data set may include multiple samples. Each sample may include a sequence of input parts and an output part. In a first example, a sequence of four input parts may be provided, wherein each input part is for a time instance. One input may comprise eight RSRP measurements from SSBs or eight CSI resources, and the output part may comprises four beam IDs that are each associated with a CSI-RS resource/TCI state for a future time instance.

In another example, the input part may comprise eight RSRP measurements from SSBs or eight CSI resources. For example, Table 3 shows four time instances (Instance-1, Instance-2, Instance-3, and Instance-4), wherein each time instance includes test data for eight inputs (Input-1, Input-2, . . . , Input-8). The output part may comprise four predicted RSRPs that are each associated with a CSI-RS resource for a future time instance. The predicted values may be formulated as relative values (e.g., the strongest RSRP is at 0 dB, the weakest RSRP is −40 dB, etc.).

TABLE 3

| Instance 1 | Instance 2 | Instance 3 | Instance 4 |
|---|---|---|---|
| Input-1 | Input-1 | Input-1 | Input-1 |
| Input-2 | Input-2 | Input-2 | Input-2 |
| Input-3 | Input-3 | Input-3 | Input-3 |
| Input-4 | Input-4 | Input-4 | Input-4 |
| Input-5 | Input-5 | Input-5 | Input-5 |
| Input-6 | Input-6 | Input-6 | Input-6 |
| Input-7 | Input-7 | Input-7 | Input-7 |
| Input-8 | Input-8 | Input-8 | Input-8 |

### Test Data Overhead Reduction.

In certain embodiments, the overhead of the test data can be represented as (N1×M1×B1)+(N2×M2×B2) bits, where N1 is the number of time instances, M1 is the number of inputs per time instance, B1 is the number of bits for representing the RSRP for each input, N2 is the number of prediction time instances (e.g., for beam management using spatial domain prediction, N2=1, for beam management using time domain prediction, N2 can be 1 or more), M2 is the number predicted beam ID/RSRP., and B2 is the number of bits for representing the RSRP for each output (in case the output is not in the form of beam ID).

For the output, if a beam ID is used, then the bitmap or combinatorial index may be used to indicate the beam ID, which can compare favorably against “M2×N2” bits. However, with N1 at 100~300 time instances, the size of the test data set cannot be considered small. It is noted a CSI-RS resource index, SSB resource index, or a TCI state index can be a beam ID

A number of ways may be used to compress the test dataset. If carried over a data plane, a source encoding algorithm may be applied to the test data. However, if the test data set is provided through RRC signaling or MAC CE to the UE, then overhead reduction may be provided, according to embodiments disclosed herein. Even though beam reporting (i.e., from the UE to the network) and test data set provision for performance monitoring (i.e., from the network to the UE) are different, the overhead reduction schemes for them may be leveraged for each other.

Thus, certain embodiments for test data provisioning from a base station to a UE use the selection and indication of strong beams, quantizer scheme for RSRPs, quantizer design, selection and indication of reference beams, and/or other aspects described above for beam reporting for AI-enabled beam management.

For example, certain embodiments for test data provisioning include the indication of selected beams from the base station to the UE per time instance or across a group of time instances.

In addition, or in other embodiments for test data provisioning, different quantization schemes may be selected for reporting RSRP values for input data and/or output data. For example, one or more (N) reference beams may be selected as reference beam(s) and the RSRP of each of the rest of the reported beams is quantized with respect to the RSRP of a reference beam, with differential quantization. Or, RSRPs of beams may be quantized separately (without differential quantization).

In addition, or in other embodiments for test data provisioning, different quantizer designs may be selected to reduce overhead for beam reporting. For example, uniform quantization (in the logarithm domain) with ceiling and floor functions may be used, or non-uniform quantization (in the logarithm domain) with ceiling and floor functions may be used.

In addition, or in other embodiments for test data provisioning, indication of reference beams may be per time instance or per group of time instances. The time instances may correspond to input data and/or output data.

In addition, or in other embodiments for test data provisioning, a bitmap or combinatorial index may indicate a strongest beam per time instance.

In addition, or in other embodiments for test data provisioning, a bitmap or combinatorial index may indicate a strongest beam across time instances.

In addition, or in other embodiments for test data provisioning, a common bitmap or common combinatorial index may be used for multiple time instances.

### Two Part Signaling for Test Dataset Construction.

If the differential RSRP is low, then depending on a channel condition, the number of beams not associated with the lowest RSRP values (e.g., −30 dB for differential beams) may vary. Consequently, the test dataset size may vary, which may lead to many blind detections on the UE side to decode the test dataset. To avoid blind detection on the UE side, then a two part signaling may be considered.

For example, in one embodiment a test dataset sample includes two parts. A first part of the test dataset sample is of a fixed size and indicates the number of selected beams in the test data. A second part of the test dataset sample is of a variable size, based on the number of selected beams indicated in the first part, to report the RSRP values of the strong beams.

In certain embodiments, when multiple bitmaps are reported for different time instances, the first part comprises a sum of the “1”s in the reported bitmaps. In other embodiments, when a common bitmap is reported for multiple time instances, the first part comprises the total number of “1”s in the common bitmap. In addition, or in other embodiments, one code state may be assigned to represent the lowest RSRP.

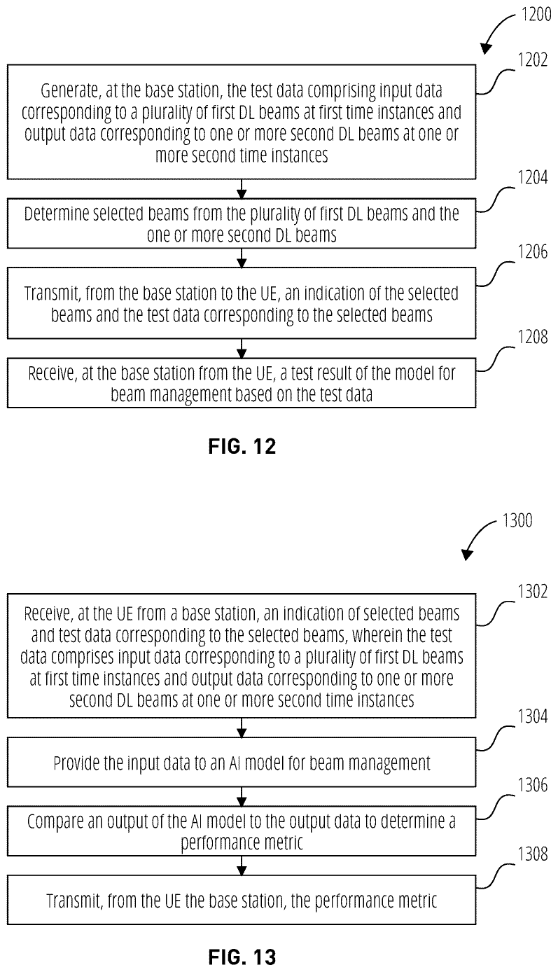

FIG. 12 is a flowchart illustrating a method 1200 for a base station to provide test data to a UE for performance monitoring of a model for beam management according to certain embodiments. The method 1200 includes generating 1202, at the base station, the test data comprising input data corresponding to a plurality of first downlink (DL) beams at first time instances and output data corresponding to one or more second DL beams at one or more second time instances. The method 1200 further includes determining 1204 selected beams from the plurality of first DL beams and the one or more second DL beams. The method 1200 further includes transmitting 1206, from the base station to the UE, an indication of the selected beams and the test data corresponding to the selected beams. The method 1200 further includes receiving 1208, at the base station from the UE, a test result of the model for beam management based on the test data.

In certain embodiments of the method 1200, determining the selected beams comprises selecting the selected beams per the first time instances.

In certain embodiments of the method 1200, a fixed number of the selected beams per the first time instances is predetermined or configured by the base station.

In certain embodiments, the method 1200 further comprising determining, by the UE, a number of the selected beams per the first time instances is within a predetermined range or a range configured by the base station.

In certain embodiments of the method 1200, the indication of the selected beams comprises a first bitmap per the first time instances indicating the selected beams.

In certain embodiments of the method 1200, the indication of the selected beams comprises a first combinatorial index per the first time instances indicating the selected beams. The first combinatorial index may be given by

$$⌈ ( {log}_{2} ( {C}_{R}^{P} ) ) ⌉$$

for a combinatorial function

$${C}_{R}^{P} ,$$

R number of reported beams, P number of measurements per the first time instances. Or, the UE may be configured to select up to R number of reported beams, and the first combinatorial index is given

$$⌈ ( {log}_{2} ( {\sum }_{r = {R}_{lowest}}^{R} {C}_{r}^{P} ) )$$

for a combinatorial function

$${C}_{R}^{P}$$

and P number of measurements per the first time instances, where r is an index and R_{lowest} is a lowest number of reported beams selected by the UE.

In certain embodiments of the method 1200, the test data comprises reference signal received power (RSRP) data for the selected beams per the first time instances. In certain embodiments, the test data does not explicitly include the RSRP data for non-selected beams from plurality of first DL beams or the one or more second DL beams.

In certain embodiments, the method 1200 further comprises: indicating, from the UE to the base station, a strongest beam per the first time instances; and quantizing an RSRP value of the strongest beam per the first time instances with a higher resolution as compared to a lower resolution used for quantizing the RSRP data of a remainder of the selected beams per the first time instances. The method may further comprise quantizing the RSRP data of the remainder of the selected beams per the first time instances using differential quantization with respect to the RSRP value of the strongest beam per the first time instances. The differential quantization may include a uniform quantization function based on a high value, a low value, and a quantization step. Or, the differential quantization may include a non-uniform quantization function based on determining quantization boundaries and minimizing a quantization error. In certain embodiments, indicating the strongest beam per the first time instances comprises using a second bitmap or a second combinatorial index given by

$$⌈ ( {log}_{2} ( {C}_{1}^{P} ) ) ⌉ .$$

In certain embodiments of the method 1200, determining the selected beams comprises selecting the selected beams across a group of the first time instances. A fixed number of the selected beams across the group of the first time instances may be predetermined or configured by the base station. Certain embodiments further include determining, by the UE, a number of the selected beams across the group of the first time instances is within a predetermined range or a range configured by the base station. The indication of the selected beams may include one or more first bitmap indicating the selected beams across the group of the first time instances, or one or more first combinatorial index indicating the selected beams across the group of the first time instances. The first combinatorial index is given by

$$⌈ ( {log}_{2} ( {C}_{R}^{P} ) ) ⌉$$

for a combinatorial function

$${C}_{R}^{P} ,$$

R number of reported beams, P number of measurements across the group of the first time instances. In certain embodiments, the UE is configured to select up to R number of reported beams, and the first combinatorial index is given

$$⌈ ( {log}_{2} ( {\sum }_{r = {R}_{lowest}}^{R} {C}_{r}^{P} ) )$$

for a combinatorial function

$${C}_{R}^{P}$$

and P number of measurements across the group of the first time instances, where r is an index and R_{lowest} is a lowest number of reported beams selected by the UE. In certain embodiments, the test data comprises reference signal received power (RSRP) data for the selected beams across the group of the first time instances. In certain embodiments, the test data does not explicitly include the RSRP data for non-selected beams from the plurality of first DL beams and the one or more second DL beams.

In certain embodiments, the method further includes: indicating, from the UE to the base station, a strongest beam in the group of the first time instances; and quantizing an RSRP value of the strongest beam in the group of the first time instances with a higher resolution as compared to a lower resolution used for quantizing the RSRP data of a remainder of the selected beams across the group of the first time instances. The method may further include quantizing the RSRP data of the remainder of the selected beams across the group of the first time instances using differential quantization with respect to the RSRP value of the strongest beam in the group of the first time instances. The differential quantization may include a uniform quantization function based on a high value, a low value, and a quantization step. Or, the differential quantization may include a non-uniform quantization function based on determining quantization boundaries and minimizing a quantization error. In certain embodiments, indicating the strongest beam in the group of the first time instances comprises using a second bitmap or a second combinatorial index given by

$$⌈ ( {log}_{2} ( {C}_{1}^{( M \cdot P )} ) ) ⌉$$

for M of the first time instances.

In certain embodiments of the method 1200, transmitting the indication of the selected beams and the test data comprises generating a report including: a first part with a fixed size to indicate a number of the selected beams; and a second part with a variable size based on the number of the selected beams to report corresponding reference signal received power (RSRP) data.

In certain embodiments of the method 1200, the input data comprises reference signal received power (RSRP) data corresponding to reference signals corresponding to the first DL beams at the first time instances. The output data may include one or more beam identifiers or beam indices corresponding to the one or more second DL beams at the one or more second time instances. Or, the output data may include a plurality of predicted RSRP values associated with the one or more second DL beams at the one or more second time instances, wherein the selected beams are selected per the second time instances or across a group of the selected time instances.

Embodiments contemplated herein include an apparatus comprising means to perform one or more elements of the method 1200. This apparatus may be, for example, an apparatus of a base station (such as a network device 1518 that is a base station, as described herein).

Embodiments contemplated herein include one or more non-transitory computer-readable media comprising instructions to cause an electronic device, upon execution of the instructions by one or more processors of the electronic device, to perform one or more elements of the method 1200. This non-transitory computer-readable media may be, for example, a memory of a base station (such as a memory 1522 of a network device 1518 that is a base station, as described herein).

Embodiments contemplated herein include an apparatus comprising logic, modules, or circuitry to perform one or more elements of the method 1200. This apparatus may be, for example, an apparatus of a base station (such as a network device 1518 that is a base station, as described herein).

Embodiments contemplated herein include an apparatus comprising: one or more processors and one or more computer-readable media comprising instructions that, when executed by the one or more processors, cause the one or more processors to perform one or more elements of the method 1200. This apparatus may be, for example, an apparatus of a base station (such as a network device 1518 that is a base station, as described herein).

Embodiments contemplated herein include a signal as described in or related to one or more elements of the method 1200.

Embodiments contemplated herein include a computer program or computer program product comprising instructions, wherein execution of the program by a processing element is to cause the processing element to carry out one or more elements of the method 1200. The processor may be a processor of a base station (such as a processor(s) 1520 of a network device 1518 that is a base station, as described herein). These instructions may be, for example, located in the processor and/or on a memory of the base station (such as a memory 1522 of a network device 1518 that is a base station, as described herein).

FIG. 13 is a flowchart illustrating a method 1300 for performance monitoring by a UE of AI enabled beam management according to certain embodiments. The method 1300 includes receiving 1302, at the UE from a base station, an indication of selected beams and test data corresponding to the selected beams, wherein the test data comprises input data corresponding to a plurality of first downlink (DL) beams at first time instances and output data corresponding to one or more second DL beams at one or more second time instances. The method 1300 further includes providing 1304 the input data to an AI model for beam management. The method 1300 further includes comparing 1306 an output of the AI model to the output data to determine a performance metric. The method 1300 further includes transmitting 1308, from the UE the base station, the performance metric.

In certain embodiments of the method 1300, the selected beams are selected per the first time instances. A fixed number of the selected beams per the first time instances may be predetermined or configured by the base station. Or, a number of the selected beams per the first time instances is within a predetermined range or a range configured by the base station.

In certain embodiments of the method 1300, the indication of the selected beams comprises a first bitmap per the first time instances indicating the selected beams or a first combinatorial index per the first time instances indicating the selected beams. The first combinatorial index is given by

$$⌈ ( {log}_{2} ( {C}_{R}^{P} ) ) ⌉$$

a combinatorial function

$${C}_{R}^{P} ,$$

R number of reported beams, P number of measurements per the first time instances. In certain embodiments, up to R number of reported beams may be selected, and wherein the first combinatorial index is given

$$⌈ ( {log}_{2} ( {\sum }_{r = {R}_{lowest}}^{R} {C}_{r}^{P} ) )$$

for a combinatorial function

$${C}_{R}^{P}$$

and P number of measurements per the first time instances, where r is an index and R_{lowest} is a lowest number of reported beams selected by the UE. The test data may include reference signal received power (RSRP) data for the selected beams per the first time instances. In certain embodiments, the test data does not explicitly include the RSRP data for non-selected beams corresponding to the first set of DL RSs measured by the UE.

In certain embodiments, the method 1300 further comprises receiving, from the UE at the base station: another indication of a strongest beam per the first time instances; and a quantized RSRP value of the strongest beam per the first time instances with a higher resolution as compared to a lower resolution used for quantizing the RSRP data of a remainder of the selected beams per the first time instances. The RSRP data of the remainder of the selected beams per the first time instances may be quantized using differential quantization with respect to the RSRP value of the strongest beam per the first time instances. The differential quantization may include a uniform quantization function based on a high value, a low value, and a quantization step. Or, the differential quantization may include a non-uniform quantization function based on quantization boundaries and a minimized quantization error. In certain embodiments, the another indication of the strongest beam per the first time instances comprises a second bitmap or a second combinatorial index given by

$$⌈ ( {log}_{2} ( {C}_{1}^{P} ) ) ⌉ .$$

In certain embodiments of the method 1300, the selected beams are selected across a group of the first time. A fixed number of the selected beams across the group of the first time instances may be predetermined or configured by the base station. Or, a number of the selected beams across the group of the first time instances may be within a predetermined range or a range configured by the base station. The indication of the selected beams may include one or more first bitmap indicating the selected beams across the group of the first time instances, or one or more first combinatorial index indicating the selected beams across the group of the first time instances. The first combinatorial index may be given by

$$⌈ ( {log}_{2} ( {C}_{R}^{P} ) ) ⌉$$

for a combinatorial function

$${C}_{R}^{P} ,$$

R number of reported beams, P number of measurements across the group of the first time instances. In certain embodiments, up to R number of reported beams are selected, and wherein the first combinatorial index is given

$$⌈ ( {log}_{2} ( {\sum }_{r = {R}_{lowest}}^{R} {C}_{R}^{P} ) )$$

for a combinatorial function

$${C}_{R}^{P}$$

and P number of measurements across the group of the first time instances, where r is an index and R_{lowest} is a lowest number of reported beams selected by the UE. The test data may include reference signal received power (RSRP) data for the selected beams across the group of the first time instances. In certain embodiments, the test data does not explicitly include the RSRP data for non-selected beams corresponding to the first set of DL RSs measured by the UE. In certain embodiments, the method further comprises receiving, from the UE at the base station: another indication of a strongest beam in the group of the first time instances; and a quantized RSRP value of the strongest beam in the group of the first time instances with a higher resolution as compared to a lower resolution used for quantizing the RSRP data of a remainder of the selected beams across the group of the first time instances. The RSRP data of the remainder of the selected beams across the group of the first time instances may be quantized using differential quantization with respect to the RSRP value of the strongest beam in the group of the first time instances. In certain embodiments, the differential quantization comprises a uniform quantization function based on a high value, a low value, and a quantization step. Or, the differential quantization may include a non-uniform quantization function based on quantization boundaries and a minimized quantization error.

The another indication of the strongest beam in the group of the first time instances comprises a second bitmap or a second combinatorial index given by

$$⌈ ( {log}_{2} ( {C}_{1}^{( M \cdot P )} ) ) ⌉$$

for M the first time instances in the group of the first time instances.

In certain embodiments of the method 1300, the indication of the selected beams and the test data comprises a report including: a first part with a fixed size to indicate a number of the selected beams; and a second part with a variable size based on the number of the selected beams to report corresponding reference signal received power (RSRP) data.

In certain embodiments of the method 1300, the input data comprises reference signal received power (RSRP) data corresponding to reference signals corresponding to the first DL beams at the first time instances. The output data may include one or more beam identifiers or beam indices corresponding to the one or more second DL beams at the one or more second time instances, or the output data may include a plurality of predicted RSRP values associated with the one or more second DL beams at the one or more second time instances. The selected beams may be selected per the second time instances or across a group of the selected time instances.

Embodiments contemplated herein include an apparatus comprising means to perform one or more elements of the method 1300. This apparatus may be, for example, an apparatus of a UE (such as a wireless device 1502 that is a UE, as described herein).

Embodiments contemplated herein include one or more non-transitory computer-readable media comprising instructions to cause an electronic device, upon execution of the instructions by one or more processors of the electronic device, to perform one or more elements of the method 1300. This non-transitory computer-readable media may be, for example, a memory of a UE (such as a memory 1506 of a wireless device 1502 that is a UE, as described herein).

Embodiments contemplated herein include an apparatus comprising logic, modules, or circuitry to perform one or more elements of the method 1300. This apparatus may be, for example, an apparatus of a UE (such as a wireless device 1502 that is a UE, as described herein).

Embodiments contemplated herein include an apparatus comprising: one or more processors and one or more computer-readable media comprising instructions that, when executed by the one or more processors, cause the one or more processors to perform one or more elements of the method 1300. This apparatus may be, for example, an apparatus of a UE (such as a wireless device 1502 that is a UE, as described herein).

Embodiments contemplated herein include a signal as described in or related to one or more elements of the method 1300.

Embodiments contemplated herein include a computer program or computer program product comprising instructions, wherein execution of the program by a processor is to cause the processor to carry out one or more elements of the method 1300. The processor may be a processor of a UE (such as a processor(s) 1504 of a wireless device 1502 that is a UE, as described herein). These instructions may be, for example, located in the processor and/or on a memory of the UE (such as a memory 1506 of a wireless device 1502 that is a UE, as described herein).

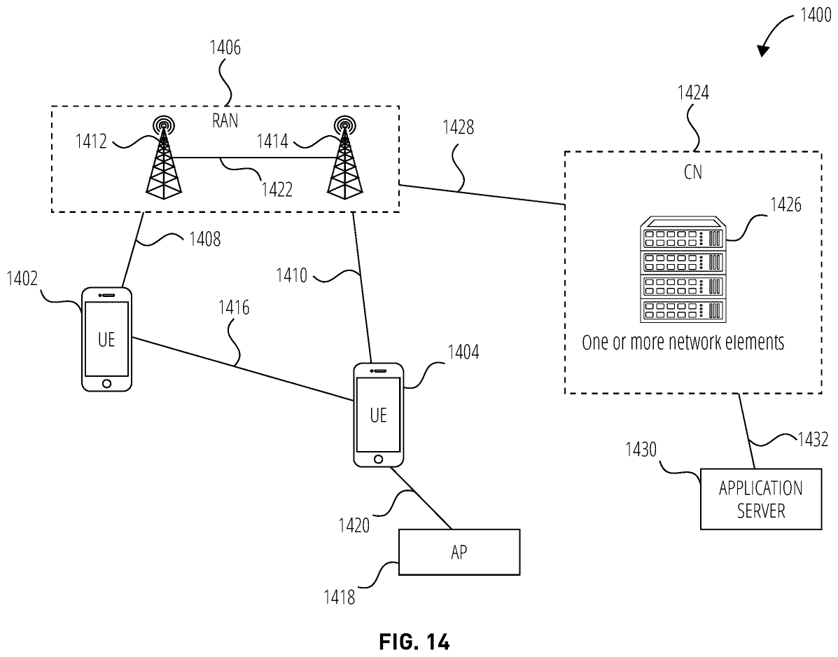

FIG. 14 illustrates an example architecture of a wireless communication system 1400, according to embodiments disclosed herein. The following description is provided for an example wireless communication system 1400 that operates in conjunction with the LTE system standards and/or 5G or NR system standards as provided by 3GPP technical specifications.

As shown by FIG. 14, the wireless communication system 1400 includes UE 1402 and UE 1404 (although any number of UEs may be used). In this example, the UE 1402 and the UE 1404 are illustrated as smartphones (e.g., handheld touchscreen mobile computing devices connectable to one or more cellular networks), but may also comprise any mobile or non-mobile computing device configured for wireless communication.

The UE 1402 and UE 1404 may be configured to communicatively couple with a RAN 1406. In embodiments, the RAN 1406 may be NG-RAN, E-UTRAN, etc. The UE 1402 and UE 1404 utilize connections (or channels) (shown as connection 1408 and connection 1410, respectively) with the RAN 1406, each of which comprises a physical communications interface. The RAN 1406 can include one or more base stations (such as base station 1412 and base station 1414) that enable the connection 1408 and connection 1410.

In this example, the connection 1408 and connection 1410 are air interfaces to enable such communicative coupling, and may be consistent with RAT(s) used by the RAN 1406, such as, for example, an LTE and/or NR.

In some embodiments, the UE 1402 and UE 1404 may also directly exchange communication data via a sidelink interface 1416. The UE 1404 is shown to be configured to access an access point (shown as AP 1418) via connection 1420. By way of example, the connection 1420 can comprise a local wireless connection, such as a connection consistent with any IEEE 802.11 protocol, wherein the AP 1418 may comprise a Wi-Fi® router. In this example, the AP 1418 may be connected to another network (for example, the Internet) without going through a CN 1424.

In embodiments, the UE 1402 and UE 1404 can be configured to communicate using orthogonal frequency division multiplexing (OFDM) communication signals with each other or with the base station 1412 and/or the base station 1414 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1412 or base station 1414 may be implemented as one or more software entities running on server computers as part of a virtual network. In addition, or in other embodiments, the base station 1412 or base station 1414 may be configured to communicate with one another via interface 1422. In embodiments where the wireless communication system 1400 is an LTE system (e.g., when the CN 1424 is an EPC), the interface 1422 may be an X2 interface. The X2 interface may be defined between two or more base stations (e.g., two or more eNBs and the like) that connect to an EPC, and/or between two eNBs connecting to the EPC. In embodiments where the wireless communication system 1400 is an NR system (e.g., when CN 1424 is a 5GC), the interface 1422 may be an Xn interface. The Xn interface is defined between two or more base stations (e.g., two or more gNBs and the like) that connect to 5GC, between a base station 1412 (e.g., a gNB) connecting to 5GC and an eNB, and/or between two eNBs connecting to 5GC (e.g., CN 1424).

The RAN 1406 is shown to be communicatively coupled to the CN 1424. The CN 1424 may comprise one or more network elements 1426, which are configured to offer various data and telecommunications services to customers/subscribers (e.g., users of UE 1402 and UE 1404) who are connected to the CN 1424 via the RAN 1406. The components of the CN 1424 may be implemented in one physical device or separate physical devices including components to read and execute instructions from a machine-readable or computer-readable medium (e.g., a non-transitory machine-readable storage medium).

In embodiments, the CN 1424 may be an EPC, and the RAN 1406 may be connected with the CN 1424 via an S1 interface 1428. In embodiments, the S1 interface 1428 may be split into two parts, an S1 user plane (S1-U) interface, which carries traffic data between the base station 1412 or base station 1414 and a serving gateway (S-GW), and the S1-MME interface, which is a signaling interface between the base station 1412 or base station 1414 and mobility management entities (MMEs).

In embodiments, the CN 1424 may be a 5GC, and the RAN 1406 may be connected with the CN 1424 via an NG interface 1428. In embodiments, the NG interface 1428 may be split into two parts, an NG user plane (NG-U) interface, which carries traffic data between the base station 1412 or base station 1414 and a user plane function (UPF), and the S1 control plane (NG-C) interface, which is a signaling interface between the base station 1412 or base station 1414 and access and mobility management functions (AMFs).

Generally, an application server 1430 may be an element offering applications that use internet protocol (IP) bearer resources with the CN 1424 (e.g., packet switched data services). The application server 1430 can also be configured to support one or more communication services (e.g., VOIP sessions, group communication sessions, etc.) for the UE 1402 and UE 1404 via the CN 1424. The application server 1430 may communicate with the CN 1424 through an IP communications interface 1432.

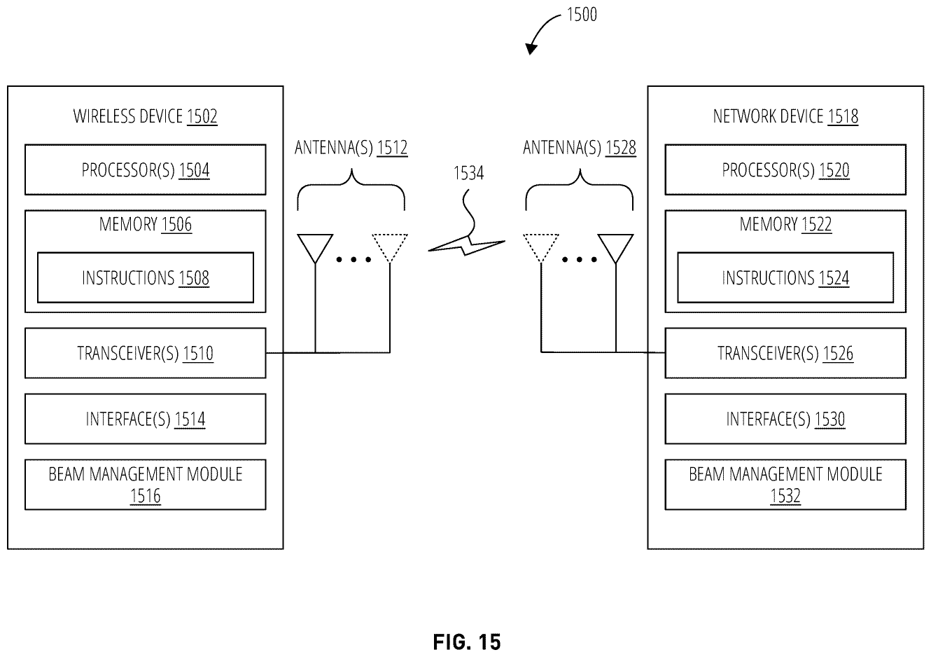

FIG. 15 illustrates a system 1500 for performing signaling 1534 between a wireless device 1502 and a network device 1518, according to embodiments disclosed herein. The system 1500 may be a portion of a wireless communications system as herein described. The wireless device 1502 may be, for example, a UE of a wireless communication system. The network device 1518 may be, for example, a base station (e.g., an eNB or a gNB) of a wireless communication system.

The wireless device 1502 may include one or more processor(s) 1504. The processor(s) 1504 may execute instructions such that various operations of the wireless device 1502 are performed, as described herein. The processor(s) 1504 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1502 may include a memory 1506. The memory 1506 may be a non-transitory computer-readable storage medium that stores instructions 1508 (which may include, for example, the instructions being executed by the processor(s) 1504). The instructions 1508 may also be referred to as program code or a computer program. The memory 1506 may also store data used by, and results computed by, the processor(s) 1504.

The wireless device 1502 may include one or more transceiver(s) 1510 that may include radio frequency (RF) transmitter circuitry and/or receiver circuitry that use the antenna(s) 1512 of the wireless device 1502 to facilitate signaling (e.g., the signaling 1534) to and/or from the wireless device 1502 with other devices (e.g., the network device 1518) according to corresponding RATs.

The wireless device 1502 may include one or more antenna(s) 1512 (e.g., one, two, four, or more). For embodiments with multiple antenna(s) 1512, the wireless device 1502 may leverage the spatial diversity of such multiple antenna(s) 1512 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1502 may be accomplished according to precoding (or digital beamforming) that is applied at the wireless device 1502 that multiplexes the data streams across the antenna(s) 1512 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1502 may implement analog beamforming techniques, whereby phases of the signals sent by the antenna(s) 1512 are relatively adjusted such that the (joint) transmission of the antenna(s) 1512 can be directed (this is sometimes referred to as beam steering).

The wireless device 1502 may include one or more interface(s) 1514. The interface(s) 1514 may be used to provide input to or output from the wireless device 1502. For example, a wireless device 1502 that is a UE may include interface(s) 1514 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1510/antenna(s) 1512 already described) that allow for communication between the UE and other devices and may operate according to known protocols (e.g., Wi-Fi®, Bluetooth®, and the like).

The wireless device 1502 may include a beam management module 1516. The beam management module 1516 may be implemented via hardware, software, or combinations thereof. For example, the beam management module 1516 may be implemented as a processor, circuit, and/or instructions 1508 stored in the memory 1506 and executed by the processor(s) 1504. In some examples, the beam management module 1516 may be integrated within the processor(s) 1504 and/or the transceiver(s) 1510. For example, the beam management module 1516 may be implemented by a combination of software components (e.g., executed by a DSP or a general processor) and hardware components (e.g., logic gates and circuitry) within the processor(s) 1504 or the transceiver(s) 1510.

The beam management module 1516 may be used for various aspects of the present disclosure, for example, aspects of FIG. 8, FIG. 10, FIG. 11, and FIG. 13.

The network device 1518 may include one or more processor(s) 1520. The processor(s) 1520 may execute instructions such that various operations of the network device 1518 are performed, as described herein. The processor(s) 1520 may include one or more baseband processors implemented using, for example, a CPU, a DSP, an ASIC, a controller, an FPGA device, another hardware device, a firmware device, or any combination thereof configured to perform the operations described herein.

The network device 1518 may include a memory 1522. The memory 1522 may be a non-transitory computer-readable storage medium that stores instructions 1524 (which may include, for example, the instructions being executed by the processor(s) 1520). The instructions 1524 may also be referred to as program code or a computer program. The memory 1522 may also store data used by, and results computed by, the processor(s) 1520.

The network device 1518 may include one or more transceiver(s) 1526 that may include RF transmitter circuitry and/or receiver circuitry that use the antenna(s) 1528 of the network device 1518 to facilitate signaling (e.g., the signaling 1534) to and/or from the network device 1518 with other devices (e.g., the wireless device 1502) according to corresponding RATs.

The network device 1518 may include one or more antenna(s) 1528 (e.g., one, two, four, or more). In embodiments having multiple antenna(s) 1528, the network device 1518 may perform MIMO, digital beamforming, analog beamforming, beam steering, etc., as has been described.

The network device 1518 may include one or more interface(s) 1530. The interface(s) 1530 may be used to provide input to or output from the network device 1518. For example, a network device 1518 that is a base station may include interface(s) 1530 made up of transmitters, receivers, and other circuitry (e.g., other than the transceiver(s) 1526/antenna(s) 1528 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1518 may include a Beam management module 1532. The Beam management module 1532 may be implemented via hardware, software, or combinations thereof. For example, the Beam management module 1532 may be implemented as a processor, circuit, and/or instructions 1524 stored in the memory 1522 and executed by the processor(s) 1520. In some examples, the Beam management module 1532 may be integrated within the processor(s) 1520 and/or the transceiver(s) 1526. For example, the Beam management module 1532 may be implemented by a combination of software components (e.g., executed by a DSP or a general processor) and hardware components (e.g., logic gates and circuitry) within the processor(s) 1520 or the transceiver(s) 1526.

The Beam management module 1532 may be used for various aspects of the present disclosure, for example, aspects of FIG. 9, FIG. 10, FIG. 11, and FIG. 12.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a user equipment (UE) to perform beam management with time domain prediction, the method comprising:
receiving, at the UE from a base station, a first configuration for a first set of downlink (DL) reference signals (RSS);
measuring, at the UE, the first set of DL RSs at a plurality of measurement occasions;
based on the measuring, determining one or more selected beams corresponding to the first set of DL RSs for reporting to the base station; and
transmitting, from the UE to the base station, an indication of the one or more selected beams and feedback data corresponding to at least one of the one or more selected beams.

2. The method of claim 1, further comprising receiving, at the UE from the base station, a second configuration for a second set of DL RSs based on the feedback data for the time domain prediction.

3. The method of claim 1, wherein determining the one or more selected beams comprises selecting the one or more selected beams per occasion of the plurality of measurement occasions.

4. The method of claim 3, wherein a fixed number of the one or more selected beams per occasion is predetermined or configured by the base station.

5. The method of claim 3, further comprising determining, by the UE, a number of the one or more selected beams per occasion is within a predetermined range or a range configured by the base station.

6. The method of claim 3, wherein the indication of the one or more selected beams comprises a first bitmap per occasion indicating the one or more selected beams.

7. The method of claim 3, wherein the indication of the one or more selected beams comprises a first combinatorial index per occasion indicating the one or more selected beams.

8. The method of claim 7, wherein the first combinatorial index is given by
$$⌈ ( {log}_{2} ( {C}_{R}^{P} ) ) ⌉$$
for a combinatorial function
$${C}_{R}^{P} ,$$
R number of reported beams, and P number of measurements per occasion.

9. The method of claim 7, wherein the UE is configured to select up to R number of reported beams, and wherein the first combinatorial index is given by
$$⌈ ( {log}_{2} ( {\sum }_{r = {R}_{lowest}}^{R} {C}_{r}^{P} ) )$$
for a combinatorial function
$${C}_{R}^{P}$$
and P number of measurements per occasion, where r is an index and R_{lowest} is a lowest number of reported beams selected by the UE.

10. The method of claim 9, wherein the feedback data comprises reference signal received power (RSRP) data for the one or more selected beams per occasion.

11. The method of claim 10, wherein the feedback data does not explicitly include the RSRP data for non-selected beams corresponding to the first set of DL RSs measured by the UE.

12. The method of claim 10, further comprising:
indicating, from the UE to the base station, a strongest beam per occasion of the plurality of measurement occasions; and
quantizing an RSRP value of the strongest beam per occasion with a higher resolution as compared to a lower resolution used for quantizing the RSRP data of a remainder of the one or more selected beams per occasion.

13. The method of claim 12, further comprising quantizing the RSRP data of the remainder of the one or more selected beams per occasion using differential quantization with respect to the RSRP value of the strongest beam per occasion.

14. The method of claim 13, wherein the differential quantization comprises a uniform quantization function based on a high value, a low value, and a quantization step.

15. The method of claim 13, wherein the differential quantization comprises a non-uniform quantization function based on determining quantization boundaries and minimizing a quantization error.

16. The method of claim 12, wherein indicating the strongest beam per occasion comprises using a second bitmap or a second combinatorial index given by
$$⌈ ( {log}_{2} ( {C}_{1}^{P} ) ) ⌉ .$$

17. The method of claim 1, wherein determining the one or more selected beams comprises selecting the one or more selected beams across a group of occasions of the plurality of measurement occasions.

18. The method of claim 17, wherein a fixed number of the one or more selected beams across the group of occasions is predetermined or configured by the base station.

19. The method of claim 17, further comprising determining, by the UE, a number of the one or more selected beams across the group of occasions is within a predetermined range or a range configured by the base station.

20. The method of claim 17, wherein the indication of the one or more selected beams comprises one or more first bitmap indicating the one or more selected beams across the group of occasions.

21-62. (canceled)
